(19) United States
(12) Patent Application Publication
(10) Pub. No.: US 2026/0186254 A1
(43) Pub. Date: Jul. 2, 2026

(54) CAMERA OPTICAL LENS

(71) Applicant: Changzhou AAC Raytech Optronics Co., Ltd., Changzhou City (CN)

(72) Inventors: Tingting Yang, Changzhou (CN); Shunda Zhou, Changzhou (CN)

(21) Appl. No.: 19/330,802

(22) Filed: Sep. 16, 2025

Related U.S. Application Data
(63) Continuation of application No. PCT/CN2024/144088, filed on Dec. 31, 2024.

(51) Int. Cl. G02B 13/00; G02B 9/64

(52) U.S. Cl. CPC G02B 13/0045; G02B 9/64

(57) ABSTRACT

Provided is a camera optical lens including seven lenses in order from an object side to an image side: first to seventh lenses; wherein focal lengths of the camera optical lens, the third lens, the sixth lens, and the seventh lens are f, f3, f6, and f7, respectively, central radii of curvature of an object side surface of the third lens, an image side surface of the third lens, an object side surface of the fourth lens, an image side surface of the fourth lens, an object side surface of the seventh lens, and an image side surface of the seventh lens are R5, R6, R7, R8, R13, and R14, respectively, and an on-axis thickness of the seventh lens is d13, and following relational expressions are satisfied: −1.35≤(R5−R6)/f3≤−0.10; 0.25≤R7/R8≤0.70; 10.00≤(R13+R14)/d13≤23.00; and 1.05<(f6−f7)/f≤1.35. The camera optical lens has excellent optical characteristics and the characteristics of large aperture, wide-angle, and ultra-thinness.

### TECHNICAL FIELD

The present disclosure relates to the field of optical lenses, and in particular, to a camera optical lens applicable to handheld terminal devices such as smart phones and digital cameras, as well as camera devices such as monitors and PC lenses.

### BACKGROUND

In recent years, with the rise of various smart devices, the demand for miniaturized camera optical lenses has been increasingly growing, and because the pixel size of photosensitive devices is reduced, plus that current electronic products regard having good functions and a light, thin and portable appearance as a development trend, the miniaturized camera optical lenses with good imaging quality have obviously become the mainstream in the current market. To obtain better imaging quality, a multi-piece lens structure is mostly adopted. Moreover, with the development of technology and the increase of users' diversified demands, under the circumstances that the pixel area of photosensitive devices keeps shrinking and a system's requirement on imaging quality keeps improving, a seven-piece lens structure has gradually appeared in lens design. There is an urgent need for a wide-angle camera optical lens with excellent optical characteristics, small volume and sufficiently corrected aberrations.

### SUMMARY

In view of the above problems, a main object of the present disclosure is to provide a camera optical lens, which has good optical performance, and at the same time, meets the design requirements of large aperture, ultra-thinness, and wide-angle.

In order to achieve the above object, a technical solution of the present disclosure provides a camera optical lens including seven lenses in order from an object side to an image side: a first lens having a positive refractive power, a second lens having a negative refractive power, a third lens having a negative refractive power, a fourth lens having a positive refractive power, a fifth lens having a negative refractive power, a sixth lens having a positive refractive power, and a seventh lens having a negative refractive power; where a focal length of the camera optical lens is f, a focal length of the third lens is f3, a focal length of the sixth lens is f6, a focal length of the seventh lens is f7, a central radius of curvature of an object side surface of the third lens is R5, a central radius of curvature of an image side surface of the third lens is R6, a central radius of curvature of an object side surface of the fourth lens is R7, a central radius of curvature of an image side surface of the fourth lens is R8, a central radius of curvature of an object side surface of the seventh lens is R13, a central radius of curvature of an image side surface of the seventh lens is R14, and an on-axis thickness of the seventh lens is d13, and following relational expressions are satisfied: −1.35<(R5−R6)/f3<−0.10; 0.25≤R7/R8≤0.70; 10.00≤(R13+R14)/d13≤23.00; and 1.05≤(f6−f7)/f≤1.35.

As an improvement, a combined focal length of the first lens and the second lens is f12, an on-axis thickness of the first lens is d1, an on-axis distance from an image side surface of the first lens to an object side surface of the second lens is d2, an on-axis thickness of the second lens is d3, and a following relational expression is satisfied: 3.90≤f12/(d1+d2+d3)≤5.40.

As an improvement, a total track length of the camera optical lens is TTL, an on-axis distance from the image side surface of the seventh lens to an image plane is BF, and a following relational expression is satisfied: 0.145<BF/TTL≤0.165.

As an improvement, 10.22≤(R13+R14)/d13≤22.96; and 1.054≤(f6−f7)/f≤1.245.

As an improvement, an object side surface of the first lens is convex in a paraxial region, and an image side surface of the first lens is concave in the paraxial region; and a focal length of the first lens is f1, a central radius of curvature of the object side surface of the first lens is R1, a central radius of curvature of the image side surface of the first lens is R2, an on-axis thickness of the first lens is d1, a total track length of the camera optical lens is TTL, and following relational expressions are satisfied: 0.973≤f1/f≤1.081; −2.22≤(R1+R2)/(R1−R2)≤−2.01; and 0.126≤d1/TTL≤0.164.

As an improvement, an object side surface of the second lens is convex in a paraxial region, and an image side surface of the second lens is concave in the paraxial region; and a focal length of the second lens is f2, a central radius of curvature of the object side surface of the second lens is R3, a central radius of curvature of the image side surface of the second lens is R4, an on-axis thickness of the second lens is d3, a total track length of the camera optical lens is TTL, and following relational expressions are satisfied: −8.72≤f2/f≤−7.54; 8.61≤(R3+R4)/(R3-R4)≤9.87; and 0.036≤d3/TTL≤0.047.

As an improvement, the object side surface of the third lens is convex in a paraxial region, and the image side surface of the third lens is concave in the paraxial region; and an on-axis thickness of the third lens L3 is d5, a total track length of the camera optical lens is TTL, and following relational expressions are satisfied: −8.31≤f3/f≤−4.10; 1.73≤(R5+R6)/(R5−R6)≤5.21; and 0.029≤d5/TTL≤0.043.

As an improvement, the object side surface of the fourth lens is convex in a paraxial region, and the image side surface of the fourth lens is concave in the paraxial region; and a focal length of the fourth lens is f4, and following relational expressions are satisfied: 5.01≤f4/f≤12.90; and −5.63≤(R7+R8)/(R7−R8)≤−1.67.

As an improvement, an object side surface of the fifth lens is convex in a paraxial region, and an image side surface of the fifth lens is concave in the paraxial region; and a focal length of the fifth lens is f5, a central radius of curvature of the object side surface of the fifth lens is R9, a central radius of curvature of the image side surface of the fifth lens is R10, and following relational expressions are satisfied: −0.98≤f5/f≤−0.87; and 1.516≤(R9+R10)/(R9−R10)≤1.641.

As an improvement, an object side surface of the sixth lens is convex in a paraxial region, and an image side surface of the sixth lens is concave in the paraxial region; and a central radius of curvature of the object side surface of the sixth lens is R11, a central radius of curvature of the image side surface of the sixth lens is R12, an on-axis thickness of the sixth lens is dii, a total track length of the camera optical lens is TTL, and following relational expressions are satisfied: 0.483≤f6/f≤0.524; and −1.25≤(R11+R12)/(R11−R12)≤−1.01.

As an improvement, the object side surface of the seventh lens is concave in a paraxial region, and the image side surface of the seventh lens is concave in the paraxial region; and a total track length of the camera optical lens is TTL, and following relational expressions are satisfied: −0.73≤f7/f≤−0.57; −0.75≤(R13+R14)/(R13−R14)≤−0.52; and 0.076≤d13/TTL≤0.095.

The present disclosure has the following conducive effects: the camera optical lens according to the present disclosure has excellent optical characteristics and the characteristics of large aperture, wide-angle, and ultra-thinness, and is particularly applicable to a mobile phone camera optical lens assembly and a WEB camera optical lens composed of camera elements such as CCD and CMOS with high resolution.

### BRIEF DESCRIPTION OF DRAWINGS

To more clearly illustrate the technical solutions in the embodiments of the present disclosure, the accompanying drawings required to be used in the description of the embodiments will be briefly introduced below. Obviously, the drawings in the following description are merely some embodiments of the present disclosure. For those of ordinary skill in the art, other drawings can also be obtained based on these drawings without creative efforts, in which:

FIG. 1 is a structural schematic diagram of a camera optical lens of a first embodiment of the present disclosure;

FIG. 2 is a schematic diagram of longitudinal aberration of the camera optical lens shown in FIG. 1;

FIG. 3 is a schematic diagram of lateral color of the camera optical lens shown in FIG. 1;

FIG. 4 is a schematic diagram of field curvature and distortion of the camera optical lens shown in FIG. 1;

FIG. 5 is a structural schematic diagram of a camera optical lens of a second embodiment of the present disclosure;

FIG. 6 is a schematic diagram of longitudinal aberration of the camera optical lens shown in FIG. 5;

FIG. 7 is a schematic diagram of lateral color of the camera optical lens shown in FIG. 5;

FIG. 8 is a schematic diagram of field curvature and distortion of the camera optical lens shown in FIG. 5;

FIG. 9 is a structural schematic diagram of a camera optical lens of a third embodiment of the present disclosure;

FIG. 10 is a schematic diagram of longitudinal aberration of the camera optical lens shown in FIG. 9;

FIG. 11 is a schematic diagram of lateral color of the camera optical lens shown in FIG. 9;

FIG. 12 is a schematic diagram of field curvature and distortion of the camera optical lens shown in FIG. 9;

FIG. 13 is a structural schematic diagram of a camera optical lens of a fourth embodiment of the present disclosure;

FIG. 14 is a schematic diagram of longitudinal aberration of the camera optical lens shown in FIG. 13;

FIG. 15 is a schematic diagram of lateral color of the camera optical lens shown in FIG. 13;

FIG. 16 is a schematic diagram of field curvature and distortion of the camera optical lens shown in FIG. 13;

FIG. 17 is a structural schematic diagram of a camera optical lens of a fifth embodiment of the present disclosure;

FIG. 18 is a schematic diagram of longitudinal aberration of the camera optical lens shown in FIG. 17;

FIG. 19 is a schematic diagram of lateral color of the camera optical lens shown in FIG. 17;

FIG. 20 is a schematic diagram of field curvature and distortion of the camera optical lens shown in FIG. 17;

FIG. 21 is a structural schematic diagram of a camera optical lens of a comparative embodiment of the present disclosure;

FIG. 22 is a schematic diagram of longitudinal aberration of the camera optical lens shown in FIG. 21;

FIG. 23 is a schematic diagram of lateral color of the camera optical lens shown in FIG. 21; and

FIG. 24 is a schematic diagram of field curvature and distortion of the camera optical lens shown in FIG. 21.

### DESCRIPTION OF EMBODIMENTS

To make the objectives, technical solutions and advantages of the present disclosure clearer, various embodiments of the present disclosure will be elaborated in detail below in conjunction with the accompanying drawings. However, those of ordinary skill in the art can understand that in the various embodiments of the present disclosure, numerous technical details are put forward to enable readers to better understand the present disclosure. Nevertheless, even without these technical details and various changes and modifications based on the following various embodiments, the technical solutions claimed by the present disclosure can still be implemented.

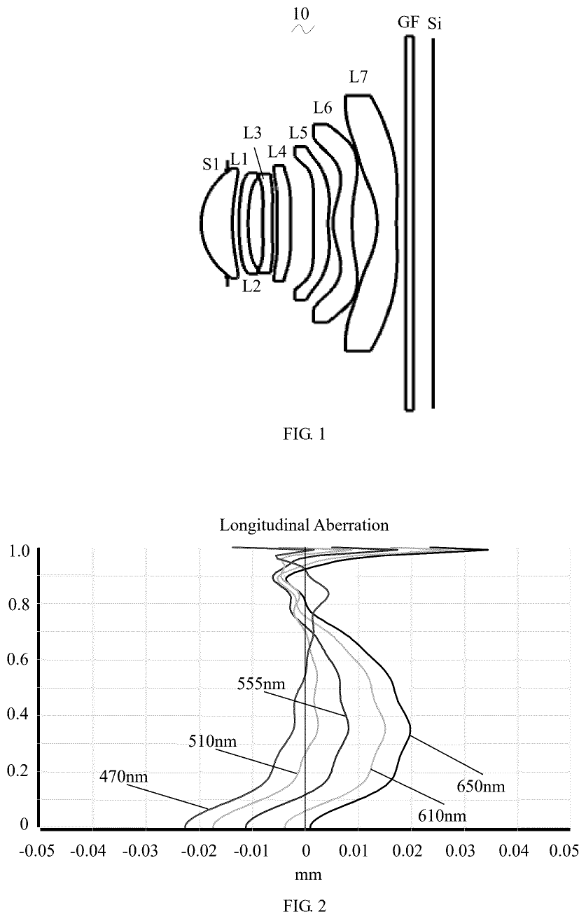

Referring to the accompanying drawings, the technical solution of the present disclosure provides a camera optical lens 10, 20, 30, 40, and 50. What are shown in FIGS. 1, 5, 9, 13, and 17 are the camera optical lenses 10, 20, 30, 40, and 50 of the present disclosure. Specifically, each of the camera optical lenses is sequentially configured from an object side to an image side with: an aperture Si, a first lens L1, a second lens L2, a third lens L3, a fourth lens L4, a fifth lens L5, a sixth lens L6, and a seventh lens L7. An optical element such as a grating filter (GF) may be provided between the seventh lens L7 and an image plane Si.

The first lens L1 is made of glass material, the second lens L2 is made of plastic material, the third lens L3 is made of plastic material, the fourth lens L4 is made of plastic material, the fifth lens L5 is made of plastic material, the sixth lens L6 is made of plastic material, and the seventh lens L7 is made of plastic material. The lenses may also be made of other materials.

A focal length of the third lens L3 is defined as f3, a central radius of curvature of an object side surface of the third lens is defined as R5, a central radius of curvature of an image side surface of the third lens is defined as R6, and a following relational expression is satisfied: −1.35≤(R5−R6)/f3<−0.10, which specifies a ratio of a difference between the central radius of curvature R5 of the object side surface of the third lens L3 and the central radius of curvature R6 of the image side surface of the third lens L3 to the focal length f3 of the third lens L3. Within the range of the above-mentioned conditional expression, reasonably controlling the surface shape of the third lens L3 is conducive to reducing the sensitivity of the system and improving the manufacturing yield of the third lens L3 by reducing the molding difficulty of the third lens L3, and meanwhile, can also reduce the stray light generated by the camera optical lens 10 and improve the imaging quality of the camera optical lens 10.

A central radius of curvature of an object side surface of the fourth lens L4 is defined as R7, a central radius of curvature of an image side surface of the fourth lens L4 is defined as R8, and a following relational expression is satisfied: 0.25≤R7/R8≤0.70, which specifies a ratio of the central radius of curvature R7 of the object side surface of the fourth lens L4 to the central radius of curvature R8 of the image side surface of the fourth lens L4, and defines the shape of the fourth lens L4. Within the range of the above-mentioned conditional expression, it is conducive to correcting the astigmatism and distortion of the camera optical lens 10, making |Distortion|≤55%, and reducing the possibility of vignetting.

A focal length of the camera optical lens 10 is defined as f, a focal length of the sixth lens L6 is defined as f6, a focal length of the seventh lens L7 is defined as f7, and a following relational expression is satisfied: 1.05≤(f6−f7)/f≤1.35, which specifies a ratio of a difference between the focal length of the sixth lens L6 and the focal length of the seventh lens L7 to the focal length f of the camera optical lens 10. Through reasonable distribution of the focal lengths, the system is allowed to have better imaging quality and lower sensitivity. Optionally, 1.054≤(f6−f7)/f1≤0.245.

A central radius of curvature of an object side surface of the seventh lens L7 is defined as R13, a central radius of curvature of an image side surface of the seventh lens L7 is defined as R14, an on-axis thickness of the seventh lens is defined as d13, and a following relational expression is satisfied: 10.00≤(R13+R14)/d13≤23.00, which specifies a ratio of a sum of the central radius of curvature R13 of the object side surface of the seventh lens L7 and the central radius of curvature R14 of the image side surface of the seventh lens L7 to the on-axis thickness d13 of the seventh lens L7. Within the range of the above-mentioned conditional expression, it is conducive to controlling the shape of the seventh lens L7, and is conducive to the molding of the seventh lens L7. Optionally, 10.22≤(R13+R14)/d13≤22.96.

In the case of satisfying the above-mentioned several conditional expressions, the camera optical lens 10, 20, 30, 40, and 50 has good optical performance, and at the same time, can meet the design requirements of large-aperture, wide-angle, and ultra-thinness; and according to the characteristics of the camera optical lens 10, 20, 30, 40, and 50, the camera optical lens 10, 20, 30, 40, and 50 is particularly applicable to a mobile phone camera lens assembly and a WEB camera lens composed of camera elements such as CCD and CMOS with high resolution.

Based on the above-mentioned conditional expressions and the achievable functions, the characteristics of the lenses are further refined as follows.

An on-axis thickness of the first lens L1 is defined as d1, an on-axis distance from an image side surface of the first lens L1 to an object side surface of the second lens L2 is defined as d2, an on-axis thickness of the second lens L2 is defined as d3, a combined focal length of the first lens L1 and the second lens L2 is defined as f12, and a following relational expression is satisfied: 3.90≤f12/(d1+d2+d3)≤5.40, which specifies a range of a ratio of the focal length to the thickness of the combination of the first lens L1 and the second lens L2 at the front end. Through reasonable distribution of the optical focal lengths of the system, the system is allowed to have better imaging quality and lower sensitivity, and at the same time to be able to maintain a reasonable thickness.

A total track length of the camera optical lens 10 is defined as TTL, an on-axis distance from the image side surface of the seventh lens L7 to an image plane is defined as BF, and a following relational expression is satisfied: 0.145≤BF/TTL≤0.165, which specifies a ratio of the on-axis distance from the image side surface of the seventh lens L7 to the image plane to the total track length of the camera optical lens. Within the range of the above-mentioned conditional expression, the camera optical lens 10 can be allowed to have a long back focal on the basis of achieving miniaturization, which is conducive to the assembly of the module, and at the same time, can effectively control the total length of the optical system.

An object side surface of the first lens L1 is convex in a paraxial region, and an image side surface of the first lens L1 is concave in the paraxial region. The first lens L1 has a positive refractive power. The object side surface and the image side surface of the first lens L1 may also be configured with other concave and convex arrangements.

A focal length of the camera optical lens 10, 20, 30, 40, and 50 is defined as f, and a focal length of the first lens L1 is defined as f1, and a following relational expression is satisfied: 0.973≤f1/f≤1.081, which specifies a ratio of the focal length f1 of the first lens L1 to the focal length f of the system. Within the specified range, the first lens has an appropriate positive refractive power, which is conducive to reducing the system aberration, and at the same time, is conducive to development of the lens to ultra-thinness and wide-angle.

A central radius of curvature of the object side surface of the first lens L1 is defined as R1, and a central radius of curvature of the image side surface of the first lens L1 is defined as R2, and a following relational expression is satisfied: −2.22≤(R1+R2)/(R1−R2)≤−2.01, which specifies a ratio of a sum of the central radius of curvature R1 of the object side surface of the first lens L1 and the central radius of curvature R2 of the image side surface of the first lens L1 to a difference between the central radius of curvature R1 of the object side surface of the first lens L1 and the central radius of curvature R2 of the image side surface of the first lens L1, and defines the shape of the first lens L1. Within the range specified by the conditional expression, the first lens L1 can effectively correct the spherical aberration of the system.

An on-axis thickness of the first lens L1 is defined as di, and a total track length of the camera optical lens 10, 20, 30, 40, and 50 is defined as TTL, and a following relational expression is satisfied: 0.126≤d1/TTL≤0.164. Within the range of the conditional expression, it is conducive to achieve ultra-thinness.

An object side surface of the second lens L2 is convex in a paraxial region, and an image side surface of the second lens L2 is concave in the paraxial region. The second lens L2 has a negative refractive power. The object side surface and the image side surface of the second lens L2 may also be configured with other concave and convex arrangements.

A focal length of the camera optical lens 10, 20, 30, 40, and 50 is defined as f, and a focal length of the second lens L2 is defined as f2, and a following relational expression is satisfied: −8.72≤f2/f≤−7.54. Controlling the negative refractive power of the second lens L2 within a reasonable range is conducive to correcting the aberration of the optical system.

A central radius of curvature of the object side surface of the second lens L2 is defined as R3, and a central radius of curvature of the image side surface of the second lens L2 is defined as R4, and a following relational expression is satisfied: 8.61≤(R3+R4)/(R3−R4)≤9.87, which specifies a ratio of a sum of the central radius of curvature R3 of the object side surface of the second lens L2 and the central radius of curvature R4 of the image side surface of the second lens L2 to a difference between the central radius of curvature R3 of the object side surface of the second lens L2 and the central radius of curvature R4 of the image side surface of the second lens L2, and defines the shape of the second lens L2. Within the range specified by the conditional expression, as the lens develops towards ultra-thin and wide-angle, it is conducive to correcting on-axis chromatic aberrations.

An on-axis thickness of the second lens L2 is defined as d3, and a total track length of the camera optical lens 10, 20, 30, 40, and 50 is defined as TTL, and a following relational expression is satisfied: 0.036≤d3/TTL≤0.047. Within the range of the conditional expression, it is conducive to achieving ultra-thinness.

An object side surface of the third lens L3 is convex in a paraxial region, and an image side surface of the third lens L3 is concave in the paraxial region. The third lens L3 has a negative refractive power. The object side surface and the image side surface of the third lens L3 may also be configured with other concave and convex arrangements.

The focal length of the camera optical lens 10, 20, 30, 40, and 50 is defined as f, and a focal length of the third lens L3 is defined as f3, and a following relational expression is satisfied: −8.31≤f3/f≤−4.10, which specifies the ratio of the focal length f3 of the third lens L3 to the focal length f of the system. Through reasonable distribution of refractive power, the system is allowed to have better imaging quality and lower sensitivity.

The central radius of curvature of the object side surface of the third lens L3 is R5, and the central radius of curvature of the image side surface of the third lens L3 is R6, and a following relational expression is satisfied: 1.73≤(R5+R6)/(R5−R6)≤5.21, which specifies the shape of the third lens L3, and specifies a ratio of a sum of the central radius of curvature R5 of the object side surface of the third lens L3 and the central radius of curvature R6 of the image side surface of the third lens L3 to a difference between the central radius of curvature R5 of the object side surface of the third lens L3 and the central radius of curvature R6 of the image 30 side surface of the third lens L3, and defines the shape of the third lens L3. Within the range specified by the conditional expression, it is conducive to the molding of the third lens L3, and the degree of deflection of light passing through the lens can be alleviated and the aberration can be effectively reduced.

An on-axis thickness of the third lens L3 is d5, and a total track length of the camera optical lens 10, 20, 30, 40, and 50 is TTL, a following relational expression is satisfied: 0.029≤d5/TTL≤0.043. Within the range of the conditional expression, it is conducive to achieve ultra-thinness.

The object side surface of the fourth lens L4 is convex in a paraxial region, and the image side surface of the fourth lens L4 is concave in the paraxial region. The fourth lens L4 has a positive refractive power. The object side surface and the image side surface of the fourth lens L4 may also be configured with other concave and convex arrangements.

A focal length of the camera optical lens 10, 20, 30, 40, and 50 is defined as f, and a focal length of the fourth lens L4 is defined as f4, and a following relational expression is satisfied: 5.01≤f4/f≤12.90, which specifies a ratio of the focal length f4 of the fourth lens L4 to the focal length f of the system. Through reasonable distribution of refractive power, the system is allowed to have better imaging quality and lower sensitivity.

The central radius of curvature of the object side surface of the fourth lens L4 is R7, and the central radius of curvature of the image side surface of the fourth lens L4 is R8, and a following relational expression is satisfied: −5.63≤(R7+R8)/(R7−R8)≤−1.67, which specifies a ratio of a sum of the central radius of curvature R7 of the object side surface of the fourth lens L4 and the central radius of curvature R8 of the image side surface of the fourth lens L4 to a difference between the central radius of curvature R7 of the object side surface of the fourth lens L4 and the central radius of curvature R8 of the image side surface of the fourth lens L4, and defines the shape of the fourth lens L4. Within the range specified by the conditional expression, with the development to ultra-thinness and wide-angle, it is conducive to correcting problems such as aberrations caused by an off-axis field angle.

An on-axis thickness of the fourth lens L4 is d7, and a total track length of the camera optical lens 10, 20, 30, 40, and 50 is TTL, and a following relational expression is satisfied: 0.052≤d7/TTL≤0.061. Within the range of the conditional expression, it is conducive to achieving ultra-thinness.

An object side surface of the fifth lens L5 is convex in a paraxial region, and an image side surface of the fifth lens L5 is concave in the paraxial region. The fifth lens L5 has a negative refractive power. The object side surface and the image side surface of the fifth lens L5 may also be configured other concave and convex arrangements.

The focal length of the camera optical lens 10, 20, 30, 40, and 50 is defined as f, a focal length of the fifth lens L5 is defied as f5, and a following relational expression is satisfied: −0.98≤f5/f≤−0.87, which specifies a ratio of the focal length f5 of the fifth lens L5 to the focal length f of the system. The definition of the fifth lens L5 may effectively make a light angle of the camera optical lens 10 smooth, thereby reducing the tolerance sensitivity.

A central radius of curvature of the object side surface of the fifth lens L5 is R9, and a central radius of curvature of the image side surface of the fifth lens L5 is R10, and a following relational expression is satisfied: 1.516≤(R9+R10)/(R9−R10)≤1.641, which specifies a ratio of a sum of the central radius of curvature R9 of the object side surface of the fifth lens L5 and the central radius of curvature R10 of the image side surface of the fifth lens L5 to a difference between the central radius of curvature R9 of the object side surface of the fifth lens L5 and the central radius of curvature R10 of the image side surface of the fifth lens L5, and defines the shape of the fifth lens L5. Within the range, with the development to ultra-thinness and wide-angle, it is conducive to correcting problems such as aberrations caused by an off-axis field angle.

An on-axis thickness of the fifth lens L5 is d9, and a total track length of the camera optical lens 10, 20, 30, 40, and 50 is TTL, and a following relational expression is satisfied: 0.062≤d9/TTL≤0.068. Within the range of the conditional expression, it is conducive to achieve ultra-thinness.

An object side surface of the sixth lens L6 is convex in a paraxial region, and an image side surface of the sixth lens L6 is concave in the paraxial region. The sixth lens L6 has positive refractive power. The object side surface and the image side surface of the sixth lens L6 may also be configured with other concave and convex arrangements.

The focal length of the camera optical lens 10, 20, 30, 40, and 50 is defined as f, and the focal length of the sixth lens L6 is defined as f6, and a following relational expression is satisfied: 0.483≤f6/f≤0.524, which specifies the ratio of the focal length f6 of the sixth lens L6 to the focal length f of the system. Within the range of the conditional expression, Through reasonable distribution of refractive power, the system is allowed to have better imaging quality and lower sensitivity.

The central radius of curvature of the object side surface of the sixth lens L6 is R11, and the central radius of curvature of the image-side surface of the sixth lens L6 is R12, and a following relational expression is satisfied: −1.25≤(R11+R12)/(R11−R12)≤−1.01, which specifies a ratio of a sum of the central radius of curvature R11 of the object side surface of the sixth lens L6 and the central radius of curvature R12 of the image side surface of the sixth lens L6 to a difference between the central radius of curvature R11 of the object side surface of the sixth lens L6 and the central radius of curvature R12 of the image side surface of the sixth lens L6, and defines the shape of the sixth lens L6. Within the range specified by the conditional expression, with the development to ultra-thinness and wide-angle, it is conducive to correcting problems such as aberrations caused by an off-axis field angle.

An on-axis thickness of the sixth lens L6 is d11, and a total track length of the camera optical lens 10, 20, 30, 40, and 50 is TTL, and a following relational expression is satisfied: 0.079≤d11/TTL≤0.086. Within the range of the conditional expression, it is conducive to achieving ultra-thinness.

The object side surface of the seventh lens L7 is concave in a paraxial region, and the image side surface of the seventh lens L7 is concave in the paraxial region. The seventh lens L7 has a negative refractive power. The object side surface and the image side surface of the seventh lens L7 may also be configured with other concave and convex arrangements.

A focal length of the camera optical lens 10, 20, 30, 40, and 50 is defined as f, and the focal length of the seventh lens L7 is defined as f7, and a following relational expression is satisfied: −0.73≤f7/f≤−0.57, which specifies a ratio of the focal length f7 of the seventh lens L7 to the focal length f of the system. Through reasonable distribution of refractive power, the system is allowed to have better imaging quality and lower sensitivity.

A central radius of curvature of the object side surface of the seventh lens L7 is R13, and a central radius of curvature of the image side surface of the seventh lens L7 is R14, and a following relational expression is satisfied: −0.75≤(R13+R14)/(R13−R14)≤−0.52, which specifies a ratio of a sum of the central radius of curvature R13 of the object side surface of the seventh lens L7 and the central radius of curvature R14 of the image side surface of the seventh lens L7 to a difference between the central radius of curvature R13 of the object side surface of the seventh lens L7 and the central radius of curvature R14 of the image side surface of the seventh lens L7, and defines the shape of the seventh lens L7. Within the range of the conditional expression, with the development to ultra-thinness and wide-angle, it is conducive to correcting problems such as aberrations caused by an off-axis field angle.

The on-axis thickness of the seventh lens L7 is d13, and a total track length of the camera optical lens 10, 20, 30, 40, and 50 is TTL, and a following relational expression is satisfied: 0.076≤d13/TTL≤0.095. Within the range of the conditional expression, it is conducive to achieving ultra-thinness.

An image height at a 1.0 field of view of the camera optical lens 10, 20, 30, 40, and 50 is IH, and a total track length of the camera optical lens 10, 20, 30, 40, and 50 is TTL, and a following relational expression is satisfied: 1.198≤TTL/IH≤1.238, thereby being conducive to achieving ultra-thinness.

The camera optical lens of the present disclosure will be described below with examples. The symbols recited in the examples are shown below. The units of the focal length, the on-axis distance, the central radius of curvature, the on-axis thickness, the inflection point position, and the arrest point position are mm.

TTL: a total track length (an on-axis distance from the object side surface of the first lens L1 to the image plane Si), in mm.

F-number FNO refers to a ratio of the effective focal length of the camera optical lens to the entrance pupil diameter.

Image height IH at the 1.0 field of view: a height of the field of view corresponding to an active pixel of a sensor (that is, half of a diagonal length of an area of the active pixel of the sensor).

Field of view FOV at the 1.0 field of view: a field of view corresponding to an active pixel of a sensor.

Image height IHm at an MIC field of view: a height of the field of view expanding beyond the 1.0 field of view for preventing assembly deviation.

Field of view FOVm at the MIC field of view: a field of view corresponding to an image height at the MIC field of view.

Optionally, the object side surface and/or the image side surface of the lens may also be provided with an inflection point and/or an arrest point, so as to meet high-quality imaging requirements.

Next, the technical solutions of the present disclosure will be specifically described with five embodiments. Meanwhile, a comparative embodiment is provided as a reference to illustrate that the technical effects of the present disclosure cannot be achieved when the ranges of the above-mentioned conditional expressions are exceeded.

### First Embodiment

Table 1 shows design data of the camera optical lens 10 according to the first embodiment of the present disclosure.

TABLE 1

| | R | d | | nd | | vd | |
|---|---|---|---|---|---|---|---|
| S1 | ∞ | d0= | −0.708 | | | | |
| R1 | 1.928 | d1= | 0.838 | nd1 | 1.4959 | v1 | 81.65 |
| R2 | 5.254 | d2= | 0.178 | | | | |
| R3 | 6.723 | d3= | 0.241 | nd2 | 1.6700 | v2 | 19.39 |
| R4 | 5.485 | d4= | 0.398 | | | | |
| R5 | 19.957 | d5= | 0.251 | nd3 | 1.6700 | v3 | 19.39 |
| R6 | 10.584 | d6= | 0.127 | | | | |
| R7 | 11.554 | d7= | 0.363 | nd4 | 1.5444 | v4 | 55.82 |
| R8 | 31.608 | d8= | 0.613 | | | | |
| R9 | 9.164 | d9= | 0.392 | nd5 | 1.5661 | v5 | 37.71 |
| R10 | 2.187 | d10= | 0.133 | | | | |
| R11 | 1.399 | d11= | 0.513 | nd6 | 1.5444 | v6 | 55.82 |
| R12 | 13.344 | d12= | 0.675 | | | | |
| R13 | −2.469 | d13= | 0.513 | nd7 | 1.5346 | v7 | 55.69 |
| R14 | 10.138 | d14= | 0.245 | | | | |
| R15 | ∞ | d15= | 0.210 | ndg | 1.5168 | vg | 64.17 |
| R16 | ∞ | d16= | 0.531 | | | | |

Where the meaning of each of the symbols is as follows:
Si: aperture;
R: radius of curvature at the center of an optical surface;
R1: central radius of curvature of the object side surface of the first lens L1;
R2: central radius of curvature of the image side surface of the first lens L1;
R3: central radius of curvature of the object side surface of the second lens L2;
R4: central radius of curvature of the image side surface of the second lens L2;
R5: central radius of curvature of the object side surface of the third lens L3;
R6: central radius of curvature of the image side surface of the third lens L3;
R7: central radius of curvature of the object side surface of the fourth lens L4;
R8: central radius of curvature of the image side surface of the fourth lens L4;
R9: central radius of curvature of the object side surface of the fifth lens L5;
R10: central radius of curvature of the image side surface of the fifth lens L5;
R11: central radius of curvature of the object side surface of the sixth lens L6;
R12: central radius of curvature of the image side surface of the sixth lens L6;
R13: central radius of curvature of the object side surface of the seventh lens L7;
R14: central radius of curvature of the image side surface of the seventh lens L7;
R15: central radius of curvature of an object side surface of the optical filter GF;
R16: central radius of curvature of an image side surface of the optical filter GF;
d: on-axis thickness of a lens, and on-axis distance between lenses;
d0: on-axis distance from the aperture Si to the object side surface of the first lens L1;
d1: on-axis thickness of the first lens L1;
d2: on-axis distance from the image side surface of the first lens L1 to the object side surface of the second lens L2;
d3: on-axis thickness of the second lens L2;
d4: on-axis distance from the image side surface of the second lens L2 to the object side surface of the third lens L3;
d5: on-axis thickness of the third lens L3;
d6: on-axis distance from the image side surface of the third lens L3 to the object side surface of the fourth lens L4;
d7: on-axis thickness of the fourth lens L4;
d8: on-axis distance from the image side surface of the fourth lens L4 to the object side surface of the fifth lens L5;
d9: on-axis thickness of the fifth lens L5;
d10: on-axis distance from the image side surface of the fifth lens L5 to the object side surface of the sixth lens L6;
d11: on-axis thickness of the sixth lens L6;
d12: on-axis distance from the image side surface of the sixth lens L6 to the object side surface of the seventh lens L7;
d13: on-axis thickness of the seventh lens L7;
d14: on-axis distance from the image side surface of the seventh lens L7 to the object side surface of the optical filter GF;
d15: on-axis thickness of the optical filter GF;
d16: on-axis distance from the image side surface of the optical filter GF to the image plane Si;
nd: refractive index for d line (which is green light with a wavelength of 550 nm);
nd1: refractive index for d line of the first lens L1;
nd2: refractive index for d line of the second lens L2;
nd3: refractive index for d line of the third lens L3;
nd4: refractive index for d line of the fourth lens L4;
nd5: refractive index for d line of the fifth lens L5;
nd6: refractive index for d line of the sixth lens L6;
nd7: refractive index for d line of the seventh lens L7;
ndg: refractive index for d line of the optical filter GF;
vd: abbe number;
v1: abbe number of the first lens L1;
v2: abbe number of the second lens L2;
v3: abbe number of the third lens L3;
v4: abbe number of the fourth lens L4;
v5: abbe number of the fifth lens L5;
v6: abbe number of the sixth lens L6;
v7: abbe number of the seventh lens L7; and
vg: abbe number of the optical filter GF.

Table 2 shows aspherical data of each of the lenses in the camera optical lens 10 according to the first Embodiment of the present disclosure.

TABLE 2

| | Conic Coefficient | Aspherical Coefficient | | | | |
|---|---|---|---|---|---|---|
| | k | A4 | A6 | A8 | A10 | A12 |
| R1 | −1.8175E−01 | −3.1800E−03 | 5.6869E−02 | −3.0817E−01 | 1.1188E+00 | −2.7407E+00 |
| R2 | −2.1939E+01 | 1.0148E−02 | −2.1525E−02 | 1.0803E−01 | −4.4258E−01 | 1.1950E+00 |
| R3 | 1.9449E+01 | −2.4417E−02 | 1.3214E−02 | −5.6358E−02 | 2.8331E−01 | −8.8996E−01 |
| R4 | 5.7275E+00 | −3.2525E−03 | −7.4926E−02 | 8.7517E−01 | −5.3578E+00 | 2.1541E+01 |
| R5 | −9.5648E+01 | −4.1121E−02 | 2.3051E−02 | 1.0801E−01 | −1.5201E+00 | 7.6520E+00 |
| R6 | −7.7840E+00 | −6.4772E−02 | 9.7703E−02 | −2.1732E−01 | 1.9008E−01 | 5.0845E−01 |
| R7 | 4.0239E+01 | −7.2098E−02 | −1.9308E−02 | 4.7743E−01 | −2.2296E+00 | 6.0784E+00 |
| R8 | 7.2663E+01 | −5.4669E−02 | −1.0286E−02 | 2.6197E−01 | −1.0346E+00 | 2.2965E+00 |
| R9 | 1.3514E+01 | −1.6922E−01 | 3.1579E−01 | −5.1326E−01 | 6.5423E−01 | −6.4472E−01 |
| R10 | −1.3376E+00 | −5.8025E−01 | 8.9784E−01 | −1.2115E+00 | 1.3060E+00 | −1.0717E+00 |
| R11 | −2.8441E+00 | −2.7514E−01 | 4.3314E−01 | −5.7844E−01 | 5.7877E−01 | −4.3679E−01 |
| R12 | 1.1778E+01 | 9.1045E−02 | −8.0216E−02 | 4.9887E−02 | −3.3934E−02 | 1.7010E−02 |
| R13 | −2.3170E+00 | −3.0291E−02 | 4.6810E−02 | −3.2820E−02 | 1.6372E−02 | −5.5898E−03 |
| R14 | −9.8753E+01 | −4.9916E−02 | 4.6178E−02 | −3.1126E−02 | 1.3227E−02 | −3.6404E−03 |
| | Conic Coefficient | Aspherical Coefficient | | | | |
| | k | A14 | A16 | A18 | A20 | A22 |
| R1 | −1.8175E−01 | 4.6656E+00 | −5.6379E+00 | 4.8951E+00 | −3.0605E+00 | 1.3648E+00 |
| R2 | −2.1939E+01 | −2.1990E+00 | 2.8491E+00 | −2.6502E+00 | 1.7814E+00 | −8.5955E−01 |
| R3 | 1.9449E+01 | 1.9138E+00 | −2.8984E+00 | 3.1304E+00 | −2.4161E+00 | 1.3202E+00 |
| R4 | 5.7275E+00 | −5.9524E+01 | 1.1640E+02 | −1.6346E+02 | 1.6532E+02 | −1.1929E+02 |
| R5 | −9.5648E+01 | −2.3476E+01 | 4.8776E+01 | −7.1392E+01 | 7.4584E+01 | −5.5362E+01 |
| R6 | −7.7840E+00 | −2.3505E+00 | 4.7689E+00 | −6.1228E+00 | 5.3662E+00 | −3.2637E+00 |
| R7 | 4.0239E+01 | −1.1090E+01 | 1.4183E+01 | −1.2960E+01 | 8.4965E+00 | −3.9582E+00 |
| R8 | 7.2663E+01 | −3.3411E+00 | 3.3658E+00 | −2.4047E+00 | 1.2271E+00 | −4.4393E−01 |
| R9 | 1.3514E+01 | 4.7979E−01 | −2.6688E−01 | 1.1028E−01 | −3.3634E−02 | 7.4664E−03 |
| R10 | −1.3376E+00 | 6.5639E−01 | −2.9731E−01 | 9.8848E−02 | −2.3898E−02 | 4.1373E−03 |
| R11 | −2.8441E+00 | 2.4330E−01 | −9.8336E−02 | 2.8627E−02 | −5.9695E−03 | 8.8153E−04 |
| R12 | 1.1778E+01 | −4.7371E−03 | 3.3922E−04 | 2.2996E−04 | −9.3276E−05 | 1.7905E−05 |
| R13 | −2.3170E+00 | 1.2970E−03 | −2.0893E−04 | 2.3858E−05 | −1.9509E−06 | 1.1382E−07 |
| R14 | −9.8753E+01 | 6.6671E−04 | −8.2101E−05 | 6.7034E−06 | −3.4015E−07 | 8.2211E−09 |

| | Conic Coefficient | Aspherical Coefficient | | | |
|---|---|---|---|---|---|
| | k | A24 | A26 | A2 | A30 |
| R1 | −1.8175E−01 | −4.2320E−01 | 8.6652E−02 | −1.0527E−02 | 5.7438E−04 |
| R2 | −2.1939E+01 | 2.9075E−01 | −6.5552E−02 | 8.8573E−03 | −5.4308E−04 |
| R3 | 1.9449E+01 | −4.9778E−01 | 1.2291E−01 | −1.7829E−02 | 1.1468E−03 |
| R4 | 5.7275E+00 | 5.9873E+01 | −1.9852E+01 | 3.9078E+00 | −3.4579E−01 |
| R5 | −9.5648E+01 | 2.8533E+01 | −9.7091E+00 | 1.9614E+00 | −1.7815E−01 |
| R6 | −7.7840E+00 | 1.3592E+00 | −3.7056E−01 | 5.9685E−02 | −4.3110E−03 |
| R7 | 4.0239E+01 | 1.2771E+00 | −2.7099E−01 | 3.3987E−02 | −1.9082E−03 |
| R8 | 7.2663E+01 | 1.1110E−01 | −1.8275E−02 | 1.7759E−03 | −7.7193E−05 |
| R9 | 1.3514E+01 | −1.1718E−03 | 1.2293E−04 | −7.7104E−06 | 2.1799E−07 |
| R10 | −1.3376E+00 | −4.9875E−04 | 3.9728E−05 | −1.8791E−06 | 3.9967E−08 |
| R11 | −2.8441E+00 | −8.9924E−05 | 6.0255E−06 | −2.3866E−07 | 4.2354E−09 |
| R12 | 1.1778E+01 | −2.0598E−06 | 1.4467E−07 | −5.7392E−09 | 9.8850E−11 |
| R13 | −2.3170E+00 | −4.6357E−09 | 1.2544E−10 | −2.0287E−12 | 1.4844E−14 |
| R14 | −9.8753E+01 | 1.1424E−10 | −1.4409E−11 | 3.9968E−13 | −4.0090E−15 |

For the sake of convenience, the aspherical surface of each of the lens surfaces adopts the aspherical surface shown in the following formula (1). However, the present disclosure is not limited to the aspherical polynomial form represented by this formula (1).

$$z = ( c {r}^{2} ) / \{ 1 + {[ 1 - ( k + 1 ) ( {c}^{2} {r}^{2} ) ]}^{1 / 2} \} + A 4 {r}^{4} + A 6 {r}^{6} + A 8 {r}^{8} + A 10 {r}^{10} + A 12 {r}^{12} + A 14 {r}^{14} + A 16 {r}^{16} + A 18 {r}^{18} + A 20 {r}^{20} + A 22 {r}^{22} + A 24 {r}^{24} + A 26 {r}^{26} + A 28 {r}^{28} + A 30 {r}^{30} \qquad ( 1 )$$

where k is a conic coefficient, A4, A6, A8, A10, A12, A14, A16, A18, A20, A22, A24, A26, A28 and A30 are aspherical coefficients, c is a curvature at the center of the optical surface, r is a vertical distance between a point on the aspheric curve and the optical axis, and z is a depth of the aspherical surface (a vertical distance between a point on the aspherical surface at a distance r from the optical axis and a tangent plane tangent to a vertex on the aspherical surface optical axis).

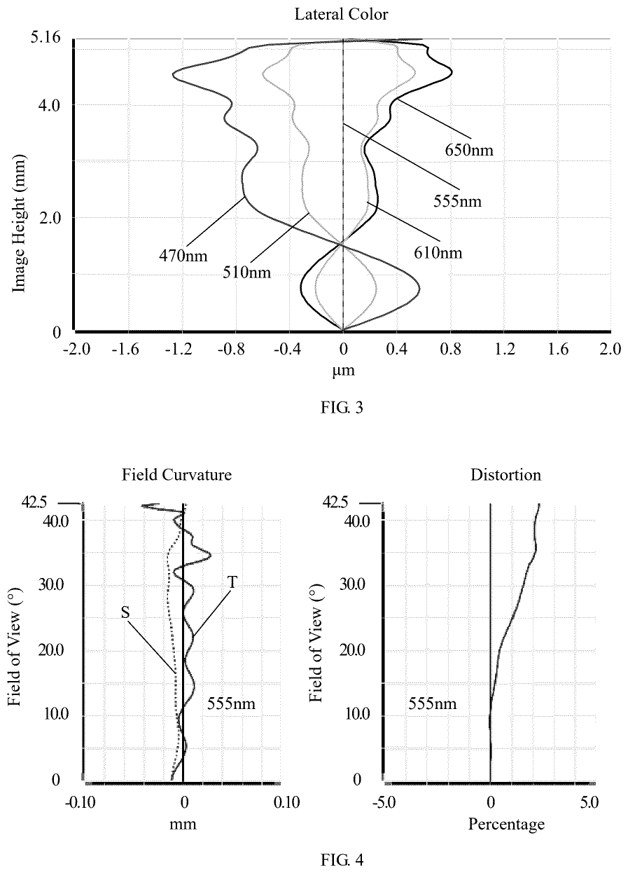

FIG. 2 and FIG. 3 respectively show longitudinal aberration and lateral color of light with wavelengths of 650 nm, 610 nm, 555 nm, 510 nm, and 470 nm after passing through the camera optical lens 10 of the first embodiment. FIG. 4 shows a schematic diagram of the field curvature and the distortion of light with a wavelength of 555 nm after passing through the camera optical lens 10 of the first embodiment. The field curvature S in FIG. 4 is a field curvature in a sagittal direction, and T is a field curvature in a meridian direction.

In this embodiment, the entrance pupil diameter ENPD of the camera optical lens 10 is 3.099 mm, the image height IH at the 1.0 field of view is 5.161 mm, the field of view FOV at the 1.0 field of view is 85.00°, the image height IHm at the MIC field of view is 5.350 mm, and the field of view FOVm at the MIC field of view is 87.40°. The camera optical lens 10 meets the design requirements of large aperture, wide-angle, and ultra-thinness, its on-axis and off-axis chromatic aberrations are sufficiently corrected, and it has excellent optical characteristics.

### Second Embodiment

The meaning of the symbols in the second embodiment is the same as that in the first embodiment.

FIG. 5 shows a camera optical lens 20 of the second embodiment of the present disclosure.

Table 3 shows design data of the camera optical lens 20 of the second embodiment of the present disclosure.

TABLE 3

| | R | d | | nd | | vd | |
|---|---|---|---|---|---|---|---|
| S1 | ∞ | d0= | −0.719 | | | | |
| R1 | 1.944 | d1= | 0.947 | nd1 | 1.4959 | v1 | 81.65 |
| R2 | 5.773 | d2= | 0.149 | | | | |
| R3 | 6.775 | d3= | 0.243 | nd2 | 1.6700 | v2 | 19.39 |
| R4 | 5.514 | d4= | 0.477 | | | | |
| R5 | 41.442 | d5= | 0.217 | nd3 | 1.6700 | v3 | 19.39 |
| R6 | 11.119 | d6= | 0.093 | | | | |
| R7 | 11.293 | d7= | 0.385 | nd4 | 1.5444 | v4 | 55.82 |
| R8 | 44.762 | d8= | 0.590 | | | | |
| R9 | 9.033 | d9= | 0.426 | nd5 | 1.5661 | v5 | 37.71 |
| R10 | 2.116 | d10= | 0.113 | | | | |
| R11 | 1.439 | d11= | 0.540 | nd6 | 1.5444 | v6 | 55.82 |
| R12 | 148.991 | d12= | 0.679 | | | | |
| R13 | −1.95 | d13= | 0.488 | nd7 | 1.5346 | v7 | 55.69 |
| R14 | 13.152 | d14= | 0.245 | | | | |
| R15 | ∞ | d15= | 0.210 | ndg | 1.5168 | vg | 64.17 |
| R16 | ∞ | d16= | 0.531 | | | | |

Table 4 shows aspherical data of each of the lenses in the camera optical lens 20 of the second embodiment of the present disclosure.

TABLE 4

| | Conic Coefficient | Aspherical Coefficient | | | | |
|---|---|---|---|---|---|---|
| | k | A4 | A6 | A8 | A10 | A12 |
| R1 | −1.8175E−01 | −3.1800E−03 | 5.6869E−02 | −3.0817E−01 | 1.1188E+00 | −2.7407E+00 |
| R2 | −2.1939E+01 | 1.0148E−02 | −2.1525E−02 | 1.0803E−01 | −4.4258E−01 | 1.1950E+00 |
| R3 | 1.9449E+01 | −2.4417E−02 | 1.3214E−02 | −5.6358E−02 | 2.8331E−01 | −8.8996E−01 |
| R4 | 5.7275E+00 | −3.2525E−03 | −7.4926E−02 | 8.7517E−01 | −5.3578E+00 | 2.1541E+01 |
| R5 | −9.5648E+01 | −4.1121E−02 | 2.3051E−02 | 1.0801E−01 | −1.5201E+00 | 7.6520E+00 |
| R6 | −7.7840E+00 | −6.4772E−02 | 9.7703E−02 | −2.1732E−01 | 1.9008E−01 | 5.0845E−01 |
| R7 | 4.0239E+01 | −7.2098E−02 | −1.9308E−02 | 4.7743E−01 | −2.2296E+00 | 6.0784E+00 |
| R8 | 7.2663E+01 | −5.4669E−02 | −1.0286E−02 | 2.6197E−01 | −1.0346E+00 | 2.2965E+00 |
| R9 | 1.3514E+01 | −1.6922E−01 | 3.1579E−01 | −5.1326E−01 | 6.5423E−01 | −6.4472E−01 |
| R10 | −1.3376E+00 | −5.8025E−01 | 8.9784E−01 | −1.2115E+00 | 1.3060E+00 | −1.0717E+00 |
| R11 | −2.8441E+00 | −2.7514E−01 | 4.3314E−01 | −5.7844E−01 | 5.7877E−01 | −4.3679E−01 |
| R12 | 1.1778E+01 | 9.1045E−02 | −8.0216E−02 | 4.9887E−02 | −3.3934E−02 | 1.7010E−02 |
| R13 | −2.3170E+00 | −3.0291E−02 | 4.6810E−02 | −3.2820E−02 | 1.6372E−02 | −5.5898E−03 |
| R14 | −9.8753E+01 | −4.9916E−02 | 4.6178E−02 | −3.1126E−02 | 1.3227E−02 | −3.6404E−03 |
| | Conic Coefficient | Aspherical Coefficient | | | | |
| | k | A14 | A16 | A18 | A20 | A22 |
| R1 | −1.8175E−01 | 4.6656E+00 | −5.6379E+00 | 4.8951E+00 | −3.0605E+00 | 1.3648E+00 |
| R2 | −2.1939E+01 | −2.1990E+00 | 2.8491E+00 | −2.6502E+00 | 1.7814E+00 | −8.5955E−01 |
| R3 | 1.9449E+01 | 1.9138E+00 | −2.8984E+00 | 3.1304E+00 | −2.4161E+00 | 1.3202E+00 |
| R4 | 5.7275E+00 | −5.9524E+01 | 1.1640E+02 | −1.6346E+02 | 1.6532E+02 | −1.1929E+02 |
| R5 | −9.5648E+01 | −2.3476E+01 | 4.8776E+01 | −7.1392E+01 | 7.4584E+01 | −5.5362E+01 |
| R6 | −7.7840E+00 | −2.3505E+00 | 4.7689E+00 | −6.1228E+00 | 5.3662E+00 | −3.2637E+00 |
| R7 | 4.0239E+01 | −1.1090E+01 | 1.4183E+01 | −1.2960E+01 | 8.4965E+00 | −3.9582E+00 |
| R8 | 7.2663E+01 | −3.3411E+00 | 3.3658E+00 | −2.4047E+00 | 1.2271E+00 | −4.4393E−01 |
| R9 | 1.3514E+01 | 4.7979E−01 | −2.6688E−01 | 1.1028E−01 | −3.3634E−02 | 7.4664E−03 |
| R10 | −1.3376E+00 | 6.5639E−01 | −2.9731E−01 | 9.8848E−02 | −2.3898E−02 | 4.1373E−03 |
| R11 | −2.8441E+00 | 2.4330E−01 | −9.8336E−02 | 2.8627E−02 | −5.9695E−03 | 8.8153E−04 |
| R12 | 1.1778E+01 | −4.7371E−03 | 3.3922E−04 | 2.2996E−04 | −9.3276E−05 | 1.7905E−05 |
| R13 | −2.3170E+00 | 1.2970E−03 | −2.0893E−04 | 2.3858E−05 | −1.9509E−06 | 1.1382E−07 |
| R14 | −9.8753E+01 | 6.6671E−04 | −8.2101E−05 | 6.7034E−06 | −3.4015E−07 | 8.2211E−09 |

| | Conic Coefficient | Aspherical Coefficient | | | |
|---|---|---|---|---|---|
| | k | A24 | A26 | A2 | A30 |
| R1 | −1.8175E−01 | −4.2320E−01 | 8.6652E−02 | −1.0527E−02 | 5.7438E−04 |
| R2 | −2.1939E+01 | 2.9075E−01 | −6.5552E−02 | 8.8573E−03 | −5.4308E−04 |
| R3 | 1.9449E+01 | −4.9778E−01 | 1.2291E−01 | −1.7829E−02 | 1.1468E−03 |
| R4 | 5.7275E+00 | 5.9873E+01 | −1.9852E+01 | 3.9078E+00 | −3.4579E−01 |
| R5 | −9.5648E+01 | 2.8533E+01 | −9.7091E+00 | 1.9614E+00 | −1.7815E−01 |
| R6 | −7.7840E+00 | 1.3592E+00 | −3.7056E−01 | 5.9685E−02 | −4.3110E−03 |
| R7 | 4.0239E+01 | 1.2771E+00 | −2.7099E−01 | 3.3987E−02 | −1.9082E−03 |
| R8 | 7.2663E+01 | 1.1110E−01 | −1.8275E−02 | 1.7759E−03 | −7.7193E−05 |
| R9 | 1.3514E+01 | −1.1718E−03 | 1.2293E−04 | −7.7104E−06 | 2.1799E−07 |
| R10 | −1.3376E+00 | −4.9875E−04 | 3.9728E−05 | −1.8791E−06 | 3.9967E−08 |
| R11 | −2.8441E+00 | −8.9924E−05 | 6.0255E−06 | −2.3866E−07 | 4.2354E−09 |
| R12 | 1.1778E+01 | −2.0598E−06 | 1.4467E−07 | −5.7392E−09 | 9.8850E−11 |
| R13 | −2.3170E+00 | −4.6357E−09 | 1.2544E−10 | −2.0287E−12 | 1.4844E−14 |
| R14 | −9.8753E+01 | 1.1424E−10 | −1.4409E−11 | 3.9968E−13 | −4.0090E−15 |

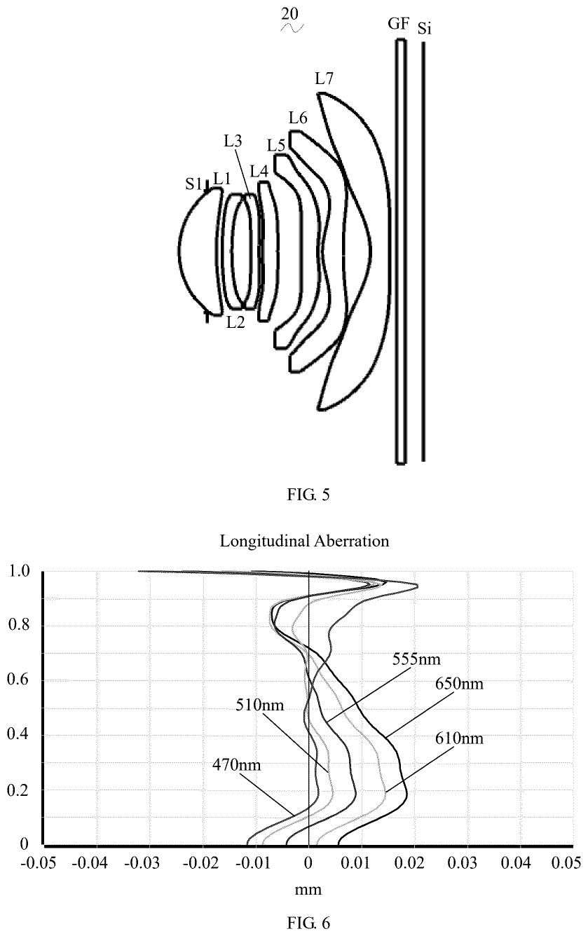

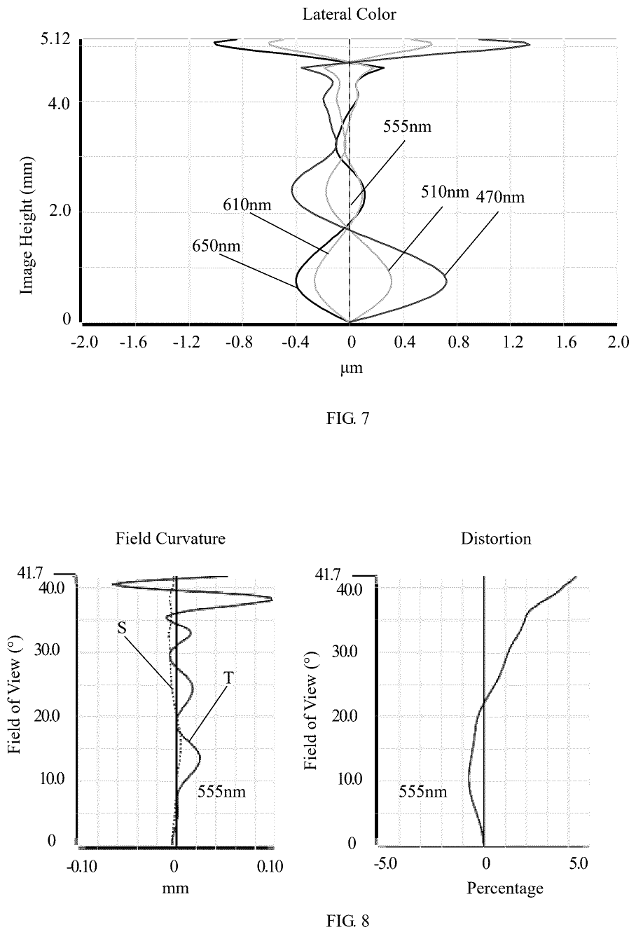

FIG. 6 and FIG. 7 respectively show schematic diagrams of longitudinal aberration and lateral color of light with wavelengths of 650 nm, 610 nm, 555 nm, 510 nm, and 470 nm after passing through the camera optical lens 20 of the second embodiment. FIG. 8 shows a schematic diagram of field curvature and distortion of light with a wavelength of 555 nm after passing through the camera optical lens 20 of the second embodiment. In FIG. 8, the field curvature S is a field curvature in a sagittal direction, and T is a field curvature in a meridian direction.

In this embodiment, the entrance pupil diameter ENPD of the camera optical lens 20 is 3.102 mm, the image height UH at the 1.0 field of view is 5.117 mm, the field of view FOV at the 1.0 field of view is 83.420, the image height IHm at the MIC field of view is 5.270 mm, and the field of view FOVm at the MIC field of view is 85.120. The camera optical lens 20 meets the design requirements of large aperture, wide-angle, and ultra-thinness, its on-axis and off-axis chromatic aberrations are sufficiently corrected, and it has excellent optical characteristics.

### Third Embodiment

The meaning of the symbols in the third embodiment is the same as that in the first embodiment.

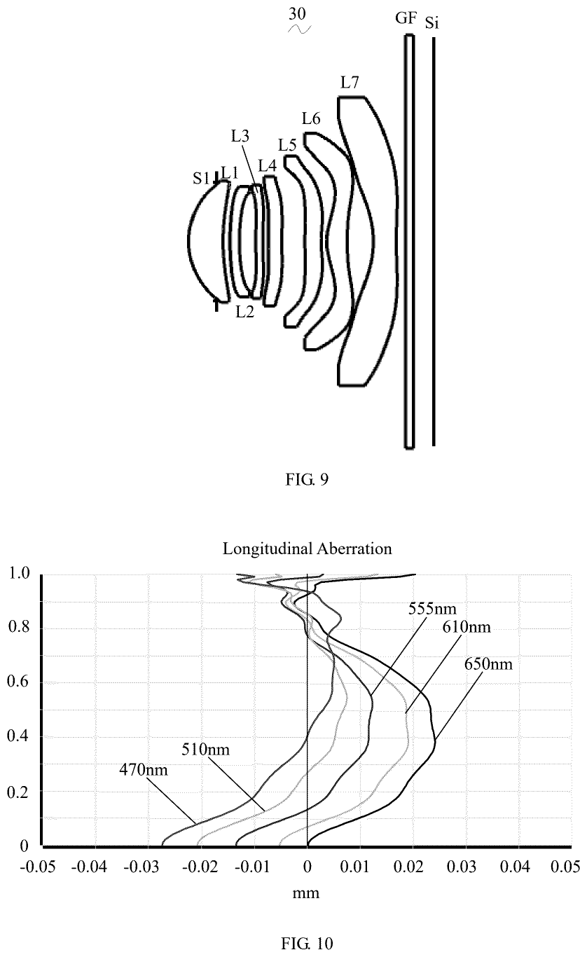

FIG. 9 shows a camera optical lens 30 of the third embodiment of the present disclosure.

Table 5 shows design data of the camera optical lens 30 of the third embodiment of the present disclosure.

TABLE 5

| | R | d | | nd | | vd | |
|---|---|---|---|---|---|---|---|
| S1 | ∞ | d0= | −0.712 | | | | |
| R1 | 1.925 | d1= | 0.876 | nd1 | 1.4959 | v1 | 81.65 |
| R2 | 5.321 | d2= | 0.177 | | | | |
| R3 | 6.742 | d3= | 0.239 | nd2 | 1.6700 | v2 | 19.39 |
| R4 | 5.457 | d4= | 0.416 | | | | |
| R5 | 14.48 | d5= | 0.183 | nd3 | 1.6700 | v3 | 19.39 |
| R6 | 9.814 | d6= | 0.134 | | | | |
| R7 | 11.997 | d7= | 0.351 | nd4 | 1.5444 | v4 | 55.82 |
| R8 | 17.189 | d8= | 0.587 | | | | |
| R9 | 9.213 | d9= | 0.411 | nd5 | 1.5661 | v5 | 37.71 |
| R10 | 2.191 | d10= | 0.139 | | | | |
| R11 | 1.392 | d11= | 0.523 | nd6 | 1.5444 | v6 | 55.82 |
| R12 | 12.92 | d12= | 0.664 | | | | |
| R13 | −2.672 | d13= | 0.587 | nd7 | 1.5346 | v7 | 55.69 |
| R14 | 8.676 | d14= | 0.230 | | | | |
| R15 | ∞ | d15= | 0.210 | ndg | 1.5168 | vg | 64.17 |
| R16 | ∞ | d16= | 0.515 | | | | |

Table 6 shows aspherical data of each of the lenses in the camera optical lens 30 of the third embodiment of the present disclosure.

TABLE 6

| | Conic Coefficient | Aspherical Coefficient | | | | |
|---|---|---|---|---|---|---|
| | k | A4 | A6 | A8 | A10 | A12 |
| R1 | −1.7677E−01 | −2.9746E−03 | 5.6866E−02 | −3.0818E−01 | 1.1188E+00 | −2.7407E+00 |
| R2 | −2.3198E+01 | 9.9658E−03 | −2.1504E−02 | 1.0808E−01 | −4.4255E−01 | 1.1950E+00 |
| R3 | 1.9515E+01 | −2.5209E−02 | 1.3248E−02 | −5.6250E−02 | 2.8335E−01 | −8.8995E−01 |
| R4 | 5.8534E+00 | −2.9319E−03 | −7.5044E−02 | 8.7520E−01 | −5.3577E+00 | 2.1541E+01 |
| R5 | −8.6454E+01 | −4.1415E−02 | 2.2908E−02 | 1.0792E−01 | −1.5201E+00 | 7.6520E+00 |
| R6 | −4.9491E+00 | −6.4554E−02 | 9.7453E−02 | −2.1750E−01 | 1.9003E−01 | 5.0846E−01 |
| R7 | 3.7364E+01 | −7.3766E−02 | −1.9268E−02 | 4.7750E−01 | −2.2296E+00 | 6.0784E+00 |
| R8 | −5.8036E+01 | −5.5707E−02 | −1.0606E−02 | 2.6189E−01 | −1.0346E+00 | 2.2965E+00 |
| R9 | 1.3803E+01 | −1.6801E−01 | 3.1578E−01 | −5.1328E−01 | 6.5423E−01 | −6.4472E−01 |
| R10 | −1.3707E+00 | −5.8079E−01 | 8.9785E−01 | −1.2115E+00 | 1.3060E+00 | −1.0717E+00 |
| R11 | −2.7701E+00 | −2.7507E−01 | 4.3312E−01 | −5.7844E−01 | 5.7877E−01 | −4.3679E−01 |
| R12 | 1.3578E+01 | 9.1233E−02 | −8.0259E−02 | 4.9869E−02 | −3.3935E−02 | 1.7010E−02 |
| R13 | −2.1169E+00 | −3.0482E−02 | 4.6795E−02 | −3.2821E−02 | 1.6372E−02 | −5.5898E−03 |
| R14 | −7.4358E+01 | −5.0867E−02 | 4.6223E−02 | −3.1124E−02 | 1.3227E−02 | −3.6404E−03 |
| | Conic Coefficient | Aspherical Coefficient | | | | |
| | k | A14 | A16 | A18 | A20 | A22 |
| R1 | −1.7677E−01 | 4.6656E+00 | −5.6379E+00 | 4.8951E+00 | −3.0605E+00 | 1.3648E+00 |
| R2 | −2.3198E+01 | −2.1990E+00 | 2.8491E+00 | −2.6502E+00 | 1.7814E+00 | −8.5955E−01 |
| R3 | 1.9515E+01 | 1.9138E+00 | −2.8984E+00 | 3.1304E+00 | −2.4161E+00 | 1.3202E+00 |
| R4 | 5.8534E+00 | −5.9524E+01 | 1.1640E+02 | −1.6346E+02 | 1.6532E+02 | −1.1929E+02 |
| R5 | −8.6454E+01 | −2.3476E+01 | 4.8776E+01 | −7.1392E+01 | 7.4584E+01 | −5.5362E+01 |
| R6 | −4.9491E+00 | −2.3505E+00 | 4.7690E+00 | −6.1228E+00 | 5.3662E+00 | −3.2637E+00 |
| R7 | 3.7364E+01 | −1.1090E+01 | 1.4183E+01 | −1.2960E+01 | 8.4965E+00 | −3.9582E+00 |
| R8 | −5.8036E+01 | −3.3411E+00 | 3.3658E+00 | −2.4047E+00 | 1.2271E+00 | −4.4393E−01 |
| R9 | 1.3803E+01 | 4.7979E−01 | −2.6688E−01 | 1.1028E−01 | −3.3634E−02 | 7.4664E−03 |
| R10 | −1.3707E+00 | 6.5639E−01 | −2.9731E−01 | 9.8848E−02 | −2.3898E−02 | 4.1373E−03 |
| R11 | −2.7701E+00 | 2.4330E−01 | −9.8336E−02 | 2.8627E−02 | −5.9695E−03 | 8.8153E−04 |
| R12 | 1.3578E+01 | −4.7371E−03 | 3.3922E−04 | 2.2996E−04 | −9.3276E−05 | 1.7905E−05 |
| R13 | −2.1169E+00 | 1.2970E−03 | −2.0893E−04 | 2.3858E−05 | −1.9509E−06 | 1.1382E−07 |
| R14 | −7.4358E+01 | 6.6671E−04 | −8.2101E−05 | 6.7034E−06 | −3.4015E−07 | 8.2211E−09 |

| | Conic Coefficient | Aspherical Coefficient | | | |
|---|---|---|---|---|---|
| | k | A24 | A26 | A2 | A30 |
| R1 | −1.7677E−01 | −4.2320E−01 | 8.6652E−02 | −1.0527E−02 | 5.7438E−04 |
| R2 | −2.3198E+01 | 2.9075E−01 | −6.5552E−02 | 8.8573E−03 | −5.4307E−04 |
| R3 | 1.9515E+01 | −4.9778E−01 | 1.2291E−01 | −1.7829E−02 | 1.1469E−03 |
| R4 | 5.8534E+00 | 5.9873E+01 | −1.9852E+01 | 3.9078E+00 | −3.4578E−01 |
| R5 | −8.6454E+01 | 2.8533E+01 | −9.7091E+00 | 1.9614E+00 | −1.7815E−01 |
| R6 | −4.9491E+00 | 1.3592E+00 | −3.7056E−01 | 5.9685E−02 | −4.3111E−03 |
| R7 | 3.7364E+01 | 1.2771E+00 | −2.7099E−01 | 3.3987E−02 | −1.9082E−03 |
| R8 | −5.8036E+01 | 1.1110E−01 | −1.8275E−02 | 1.7759E−03 | −7.7193E−05 |
| R9 | 1.3803E+01 | −1.1718E−03 | 1.2293E−04 | −7.7104E−06 | 2.1799E−07 |
| R10 | −1.3707E+00 | −4.9875E−04 | 3.9728E−05 | −1.8791E−06 | 3.9967E−08 |
| R11 | −2.7701E+00 | −8.9924E−05 | 6.0255E−06 | −2.3866E−07 | 4.2354E−09 |
| R12 | 1.3578E+01 | −2.0598E−06 | 1.4467E−07 | −5.7392E−09 | 9.8850E−11 |
| R13 | −2.1169E+00 | −4.6357E−09 | 1.2544E−10 | −2.0287E−12 | 1.4844E−14 |
| R14 | −7.4358E+01 | 1.1424E−10 | −1.4409E−11 | 3.9968E−13 | −4.0090E−15 |

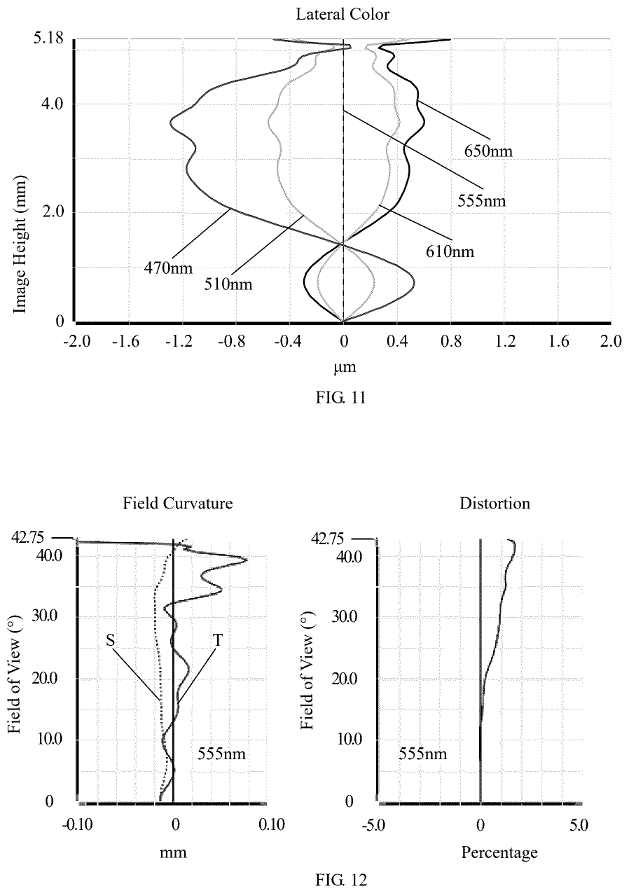

FIG. 10 and FIG. 11 respectively show schematic diagrams of longitudinal aberration and lateral color of light with wavelengths of 650 nm, 610 nm, 555 nm, 510 nm, and 470 nm after passing through the camera optical lens 30 of third embodiment. FIG. 12 shows a schematic diagram of field curvature and distortion of light with a wavelength of 555 nm after passing through the camera optical lens 30 of the third embodiment. In FIG. 12, the field curvature S is a field curvature in a sagittal direction, and T is a field curvature in a meridian direction.

In this embodiment, the entrance pupil diameter ENPD of the camera optical lens 30 is 3.112 mm, the image height IH at the 1.0 field of view is 5.182 mm, the field of view FOV at the 1.0 field of view is 85.50°, the image height IHm at the MIC field of view is 5.289 mm, and the field of view FOVm at the MIC field of view is 86.85°. The camera optical lens 30 meets the design requirements of large aperture, wide-angle, and ultra-thinness, its on-axis and off-axis chromatic aberrations are sufficiently corrected, and it has excellent optical characteristics.

### Fourth Embodiment

The meaning of the symbols in the fourth embodiment is the same as that in the first embodiment.

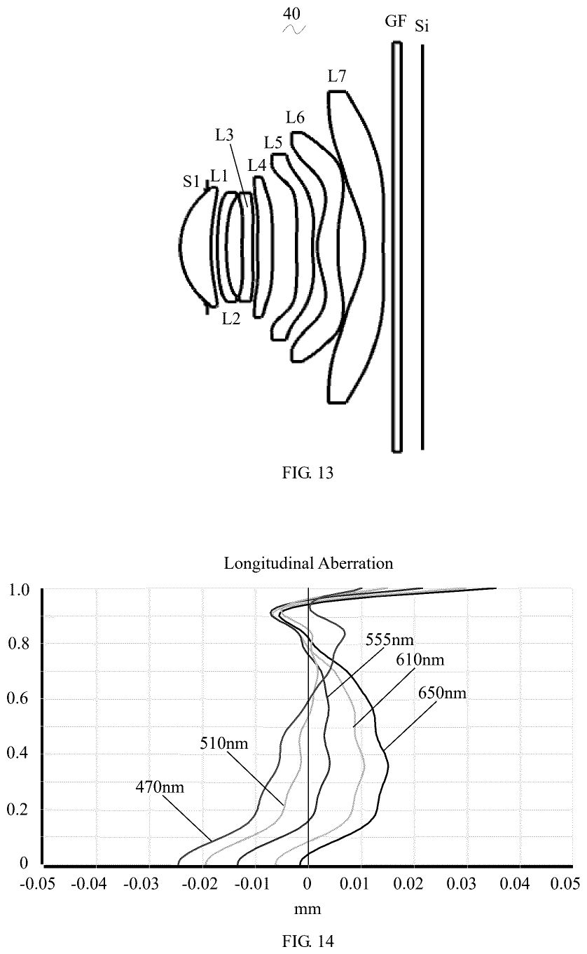

FIG. 13 shows a camera optical lens 40 of the fourth embodiment of the present disclosure.

Table 7 shows design data of the camera optical lens 40 of the fourth embodiment of the present disclosure.

TABLE 7

| | R | d | | nd | | vd | |
|---|---|---|---|---|---|---|---|
| S1 | ∞ | d0= | −0.689 | | | | |
| R1 | 1.927 | d1= | 0.783 | nd1 | 1.4959 | v1 | 81.65 |
| R2 | 5.095 | d2= | 0.165 | | | | |
| R3 | 6.704 | d3= | 0.226 | nd2 | 1.6700 | v2 | 19.39 |
| R4 | 5.427 | d4= | 0.408 | | | | |
| R5 | 15.58 | d5= | 0.261 | nd3 | 1.6700 | v3 | 19.39 |
| R6 | 9.481 | d6= | 0.131 | | | | |
| R7 | 11.303 | d7= | 0.375 | nd4 | 1.5444 | v4 | 55.82 |
| R8 | 35.845 | d8= | 0.619 | | | | |
| R9 | 9.057 | d9= | 0.401 | nd5 | 1.5661 | v5 | 37.71 |
| R10 | 2.198 | d10= | 0.126 | | | | |
| R11 | 1.387 | d11= | 0.527 | nd6 | 1.5444 | v6 | 55.82 |
| R12 | 13.171 | d12= | 0.686 | | | | |
| R13 | −2.500 | d13= | 0.471 | nd7 | 1.5346 | v7 | 55.69 |
| R14 | 12.482 | d14= | 0.251 | | | | |
| R15 | ∞ | d15= | 0.210 | ndg | 1.5168 | vg | 64.17 |
| R16 | ∞ | d16= | 0.537 | | | | |

Table 8 shows aspherical data of each of the lenses in the camera optical lens 40 of the fourth embodiment of the present disclosure.

TABLE 8

| | Conic Coefficient | Aspherical Coefficient | | | | |
|---|---|---|---|---|---|---|
| | k | A4 | A6 | A8 | A10 | A12 |
| R1 | −1.6874E−01 | −2.3696E−03 | 5.6962E−02 | −3.0816E−01 | 1.1188E+00 | −2.7407E+00 |
| R2 | −2.1563E+01 | 1.0384E−02 | −2.1464E−02 | 1.0806E−01 | −4.4256E−01 | 1.1950E+00 |
| R3 | 1.9428E+01 | −2.4847E−02 | 1.3303E−02 | −5.6277E−02 | 2.8337E−01 | −8.8995E−01 |
| R4 | 5.8596E+00 | −2.7626E−03 | −7.5054E−02 | 8.7511E−01 | −5.3578E+00 | 2.1541E+01 |
| R5 | −8.6710E+01 | −4.1014E−02 | 2.2824E−02 | 1.0801E−01 | −1.5201E+00 | 7.6519E+00 |
| R6 | −7.8554E+00 | −6.4765E−02 | 9.7715E−02 | −2.1730E−01 | 1.9008E−01 | 5.0848E−01 |
| R7 | 4.0315E+01 | −7.2193E−02 | −1.9128E−02 | 4.7744E−01 | −2.2296E+00 | 6.0784E+00 |
| R8 | −1.4813E+01 | −5.5229E−02 | −1.0648E−02 | 2.6190E−01 | −1.0346E+00 | 2.2965E+00 |
| R9 | 1.3397E+01 | −1.6896E−01 | 3.1573E−01 | −5.1329E−01 | 6.5423E−01 | −6.4472E−01 |
| R10 | −1.4100E+00 | −5.8036E−01 | 8.9789E−01 | −1.2115E+00 | 1.3060E+00 | −1.0717E+00 |
| R11 | −2.7931E+00 | −2.7502E−01 | 4.3309E−01 | −5.7844E−01 | 5.7877E−01 | −4.3679E−01 |
| R12 | 1.0837E+01 | 9.1199E−02 | −8.0226E−02 | 4.9882E−02 | −3.3934E−02 | 1.7010E−02 |
| R13 | −2.2981E+00 | −3.0569E−02 | 4.6805E−02 | −3.2820E−02 | 1.6372E−02 | −5.5898E−03 |
| R14 | −2.7995E+01 | −5.0432E−02 | 4.6161E−02 | −3.1125E−02 | 1.3228E−02 | −3.6404E−03 |
| | Conic Coefficient | Aspherical Coefficient | | | | |
| | k | A14 | A16 | A18 | A20 | A22 |
| R1 | −1.6874E−01 | 4.6656E+00 | −5.6379E+00 | 4.8951E+00 | −3.0605E+00 | 1.3648E+00 |
| R2 | −2.1563E+01 | −2.1990E+00 | 2.8491E+00 | −2.6502E+00 | 1.7814E+00 | −8.5955E−01 |
| R3 | 1.9428E+01 | 1.9138E+00 | −2.8984E+00 | 3.1304E+00 | −2.4161E+00 | 1.3202E+00 |
| R4 | 5.8596E+00 | −5.9524E+01 | 1.1640E+02 | −1.6346E+02 | 1.6532E+02 | −1.1929E+02 |
| R5 | −8.6710E+01 | −2.3476E+01 | 4.8776E+01 | −7.1392E+01 | 7.4584E+01 | −5.5362E+01 |
| R6 | −7.8554E+00 | −2.3505E+00 | 4.7689E+00 | −6.1228E+00 | 5.3662E+00 | −3.2637E+00 |
| R7 | 4.0315E+01 | −1.1090E+01 | 1.4183E+01 | −1.2960E+01 | 8.4965E+00 | −3.9582E+00 |
| R8 | −1.4813E+01 | −3.3411E+00 | 3.3658E+00 | −2.4047E+00 | 1.2271E+00 | −4.4393E−01 |
| R9 | 1.3397E+01 | 4.7979E−01 | −2.6688E−01 | 1.1028E−01 | −3.3634E−02 | 7.4664E−03 |
| R10 | −1.4100E+00 | 6.5639E−01 | −2.9731E−01 | 9.8848E−02 | −2.3898E−02 | 4.1373E−03 |
| R11 | −2.7931E+00 | 2.4330E−01 | −9.8336E−02 | 2.8627E−02 | −5.9695E−03 | 8.8153E−04 |
| R12 | 1.0837E+01 | −4.7371E−03 | 3.3922E−04 | 2.2996E−04 | −9.3276E−05 | 1.7905E−05 |
| R13 | −2.2981E+00 | 1.2970E−03 | −2.0893E−04 | 2.3858E−05 | −1.9509E−06 | 1.1382E−07 |
| R14 | −2.7995E+01 | 6.6671E−04 | −8.2101E−05 | 6.7034E−06 | −3.4015E−07 | 8.2211E−09 |

| | Conic Coefficient | Aspherical Coefficient | | | |
|---|---|---|---|---|---|
| | k | A24 | A26 | A2 | A30 |
| R1 | −1.6874E−01 | −4.2320E−01 | 8.6652E−02 | −1.0527E−02 | 5.7438E−04 |
| R2 | −2.1563E+01 | 2.9075E−01 | −6.5552E−02 | 8.8573E−03 | −5.4308E−04 |
| R3 | 1.9428E+01 | −4.9778E−01 | 1.2291E−01 | −1.7829E−02 | 1.1467E−03 |
| R4 | 5.8596E+00 | 5.9873E+01 | −1.9852E+01 | 3.9078E+00 | −3.4579E−01 |
| R5 | −8.6710E+01 | 2.8533E+01 | −9.7091E+00 | 1.9614E+00 | −1.7815E−01 |
| R6 | −7.8554E+00 | 1.3592E+00 | −3.7056E−01 | 5.9685E−02 | −4.3111E−03 |
| R7 | 4.0315E+01 | 1.2771E+00 | −2.7099E−01 | 3.3987E−02 | −1.9082E−03 |
| R8 | −1.4813E+01 | 1.1110E−01 | −1.8275E−02 | 1.7759E−03 | −7.7194E−05 |
| R9 | 1.3397E+01 | −1.1718E−03 | 1.2293E−04 | −7.7104E−06 | 2.1799E−07 |
| R10 | −1.4100E+00 | −4.9875E−04 | 3.9728E−05 | −1.8791E−06 | 3.9967E−08 |
| R11 | −2.7931E+00 | −8.9924E−05 | 6.0255E−06 | −2.3866E−07 | 4.2354E−09 |
| R12 | 1.0837E+01 | −2.0598E−06 | 1.4467E−07 | −5.7392E−09 | 9.8850E−11 |
| R13 | −2.2981E+00 | −4.6357E−09 | 1.2544E−10 | −2.0287E−12 | 1.4844E−14 |
| R14 | −2.7995E+01 | 1.1424E−10 | −1.4409E−11 | 3.9968E−13 | −4.0090E−15 |

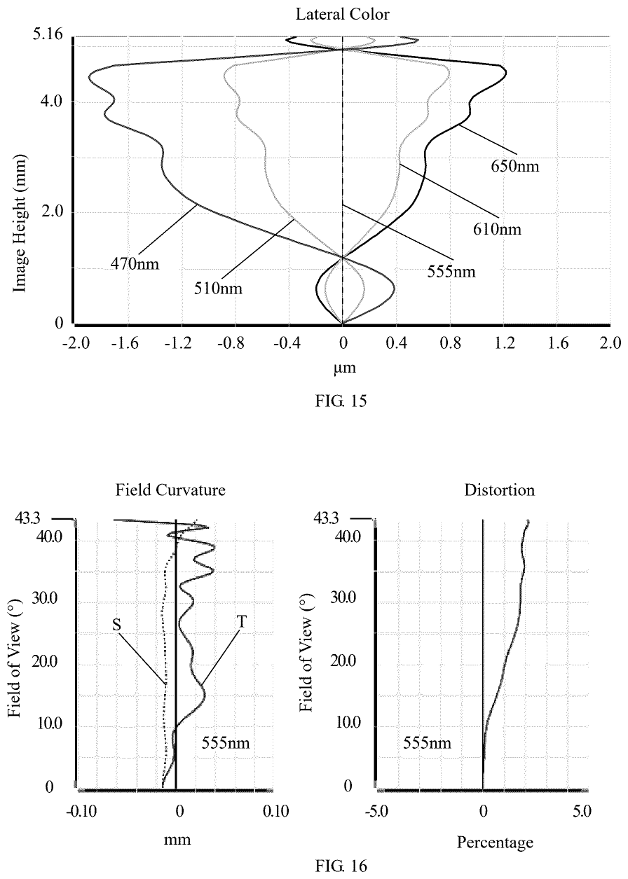

FIG. 14 and FIG. 15 respectively show schematic diagrams of longitudinal aberration and lateral color of light with wavelengths of 650 nm, 610 nm, 555 nm, 510 nm, and 470 nm after passing through the camera optical lens 40 of the fourth embodiment. FIG. 16 shows a schematic diagram of field curvature and distortion of light with a wavelength of 555 nm after passing through the camera optical lens 40 of the fourth embodiment. In FIG. 12, the field curvature S is a field curvature in a sagittal direction, and T is a field curvature in a meridian direction.

In this embodiment, the entrance pupil diameter ENPD of the camera optical lens 40 is 3.014 mm, the image height IH at the 1.0 field of view is 5.156 mm, the field of view FOV at the 1.0 field of view is 86.60°, the image height IHm at the MIC field of view is 5.294 mm, and the field of view FOVm at the MIC field of view is 88.28°. The camera optical lens 40 meets the design requirements of large aperture, wide-angle, and ultra-thinness, its on-axis and off-axis chromatic aberrations are sufficiently corrected, and it has excellent optical characteristics.

### Fifth Embodiment

The meaning of the symbols in the fifth embodiment is the same as that in the first embodiment.

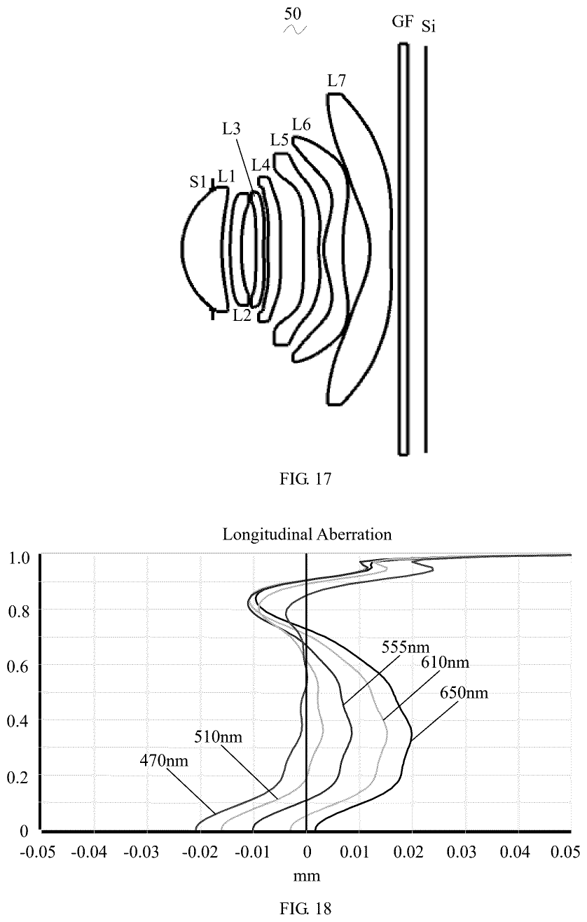

FIG. 17 shows a camera optical lens 50 of the fifth embodiment of the present disclosure.

Table 9 shows design data of the camera optical lens 50 of the fifth embodiment of the present disclosure.

TABLE 9

| | R | d | | nd | | vd | |
|---|---|---|---|---|---|---|---|
| S1 | ∞ | d0= | −0.781 | | | | |
| R1 | 1.919 | d1= | 1.016 | nd1 | 1.4959 | v1 | 81.65 |
| R2 | 5.469 | d2= | 0.208 | | | | |
| R3 | 6.867 | d3= | 0.289 | nd2 | 1.6700 | v2 | 19.39 |
| R4 | 5.439 | d4= | 0.367 | | | | |
| R5 | 45.181 | d5= | 0.202 | nd3 | 1.6700 | v3 | 19.39 |
| R6 | 13.924 | d6= | 0.107 | | | | |
| R7 | 12.383 | d7= | 0.325 | nd4 | 1.5444 | v4 | 55.82 |
| R8 | 35.296 | d8= | 0.581 | | | | |
| R9 | 10.578 | d9= | 0.389 | nd5 | 1.5661 | v5 | 37.71 |
| R10 | 2.172 | d10= | 0.128 | | | | |
| R11 | 1.417 | d11= | 0.494 | nd6 | 1.5444 | v6 | 55.82 |
| R12 | 14.721 | d12= | 0.681 | | | | |
| R13 | −2.419 | d13= | 0.531 | nd7 | 1.5346 | v7 | 55.69 |
| R14 | 11.289 | d14= | 0.224 | | | | |
| R15 | ∞ | d15= | 0.210 | ndg | 1.5168 | vg | 64.17 |
| R16 | ∞ | d16= | 0.473 | | | | |

Table 10 shows aspherical data of each of the lenses in the camera optical lens 50 of the fifth embodiment of the present disclosure.

TABLE 10

| | Conic Coefficient | Aspherical Coefficient | | | | |
|---|---|---|---|---|---|---|
| | k | A4 | A6 | A8 | A10 | A12 |
| R1 | −1.8911E−01 | −3.7253E−03 | 5.6508E−02 | −3.0826E−01 | 1.1188E+00 | −2.7407E+00 |
| R2 | −2.3225E+01 | 9.5063E−03 | −2.1983E−02 | 1.0811E−01 | −4.4251E−01 | 1.1950E+00 |
| R3 | 1.9320E+01 | −2.5035E−02 | 1.2719E−02 | −5.6259E−02 | 2.8319E−01 | −8.8996E−01 |
| R4 | 5.7086E+00 | −2.3914E−03 | −7.5350E−02 | 8.7567E−01 | −5.3578E+00 | 2.1541E+01 |
| R5 | −8.5958E+01 | −4.1980E−02 | 2.1023E−02 | 1.0848E−01 | −1.5202E+00 | 7.6521E+00 |
| R6 | −1.3756E+01 | −6.6107E−02 | 9.7214E−02 | −2.1710E−01 | 1.8997E−01 | 5.0837E−01 |
| R7 | 3.8527E+01 | −7.4561E−02 | −1.9181E−02 | 4.7744E−01 | −2.2297E+00 | 6.0784E+00 |
| R8 | −8.1380E+01 | −5.4850E−02 | −1.1559E−02 | 2.6185E−01 | −1.0346E+00 | 2.2965E+00 |
| R9 | 1.2362E+01 | −1.6889E−01 | 3.1581E−01 | −5.1339E−01 | 6.5422E−01 | −6.4472E−01 |
| R10 | −1.3986E+00 | −5.8160E−01 | 8.9778E−01 | −1.2115E+00 | 1.3060E+00 | −1.0717E+00 |
| R11 | −2.9117E+00 | −2.7489E−01 | 4.3316E−01 | −5.7843E−01 | 5.7877E−01 | −4.3679E−01 |
| R12 | 1.8068E+01 | 8.9799E−02 | −8.0066E−02 | 4.9872E−02 | −3.3936E−02 | 1.7010E−02 |
| R13 | −2.0536E+00 | −3.0492E−02 | 4.6800E−02 | −3.2821E−02 | 1.6372E−02 | −5.5898E−03 |
| R14 | −1.8395E+02 | −5.0074E−02 | 4.6094E−02 | −3.1122E−02 | 1.3227E−02 | −3.6404E−03 |
| | Conic Coefficient | Aspherical Coefficient | | | | |
| | k | A14 | A16 | A18 | A20 | A22 |
| R1 | −1.8911E−01 | 4.6656E+00 | −5.6379E+00 | 4.8951E+00 | −3.0605E+00 | 1.3648E+00 |
| R2 | −2.3225E+01 | −2.1990E+00 | 2.8491E+00 | −2.6502E+00 | 1.7814E+00 | −8.5955E−01 |
| R3 | 1.9320E+01 | 1.9138E+00 | −2.8984E+00 | 3.1304E+00 | −2.4161E+00 | 1.3202E+00 |
| R4 | 5.7086E+00 | −5.9524E+01 | 1.1640E+02 | −1.6346E+02 | 1.6532E+02 | −1.1929E+02 |
| R5 | −8.5958E+01 | −2.3476E+01 | 4.8776E+01 | −7.1392E+01 | 7.4584E+01 | −5.5362E+01 |
| R6 | −1.3756E+01 | −2.3506E+00 | 4.7689E+00 | −6.1228E+00 | 5.3662E+00 | −3.2637E+00 |
| R7 | 3.8527E+01 | −1.1090E+01 | 1.4183E+01 | −1.2960E+01 | 8.4965E+00 | −3.9582E+00 |
| R8 | −8.1380E+01 | −3.3411E+00 | 3.3658E+00 | −2.4047E+00 | 1.2271E+00 | −4.4393E−01 |
| R9 | 1.2362E+01 | 4.7979E−01 | −2.6688E−01 | 1.1028E−01 | −3.3634E−02 | 7.4664E−03 |
| R10 | −1.3986E+00 | 6.5639E−01 | −2.9731E−01 | 9.8848E−02 | −2.3898E−02 | 4.1373E−03 |
| R11 | −2.9117E+00 | 2.4330E−01 | −9.8336E−02 | 2.8627E−02 | −5.9695E−03 | 8.8153E−04 |
| R12 | 1.8068E+01 | −4.7371E−03 | 3.3922E−04 | 2.2996E−04 | −9.3276E−05 | 1.7905E−05 |
| R13 | −2.0536E+00 | 1.2970E−03 | −2.0893E−04 | 2.3858E−05 | −1.9509E−06 | 1.1382E−07 |
| R14 | −1.8395E+02 | 6.6671E−04 | −8.2101E−05 | 6.7034E−06 | −3.4015E−07 | 8.2211E−09 |

| | Conic Coefficient | Aspherical Coefficient | | | |
|---|---|---|---|---|---|
| | k | A24 | A26 | A2 | A30 |
| R1 | −1.8911E−01 | −4.2320E−01 | 8.6652E−02 | −1.0527E−02 | 5.7439E−04 |
| R2 | −2.3225E+01 | 2.9075E−01 | −6.5552E−02 | 8.8573E−03 | −5.4304E−04 |
| R3 | 1.9320E+01 | −4.9778E−01 | 1.2291E−01 | −1.7829E−02 | 1.1473E−03 |
| R4 | 5.7086E+00 | 5.9873E+01 | −1.9852E+01 | 3.9078E+00 | −3.4578E−01 |
| R5 | −8.5958E+01 | 2.8533E+01 | −9.7091E+00 | 1.9614E+00 | −1.7815E−01 |
| R6 | −1.3756E+01 | 1.3592E+00 | −3.7056E−01 | 5.9685E−02 | −4.3111E−03 |
| R7 | 3.8527E+01 | 1.2771E+00 | −2.7099E−01 | 3.3987E−02 | −1.9082E−03 |
| R8 | −8.1380E+01 | 1.1110E−01 | −1.8275E−02 | 1.7759E−03 | −7.7194E−05 |
| R9 | 1.2362E+01 | −1.1718E−03 | 1.2293E−04 | −7.7104E−06 | 2.1799E−07 |
| R10 | −1.3986E+00 | −4.9875E−04 | 3.9728E−05 | −1.8791E−06 | 3.9967E−08 |
| R11 | −2.9117E+00 | −8.9924E−05 | 6.0255E−06 | −2.3866E−07 | 4.2354E−09 |
| R12 | 1.8068E+01 | −2.0598E−06 | 1.4467E−07 | −5.7392E−09 | 9.8849E−11 |
| R13 | −2.0536E+00 | −4.6357E−09 | 1.2544E−10 | −2.0287E−12 | 1.4844E−14 |
| R14 | −1.8395E+02 | 1.1424E−10 | −1.4409E−11 | 3.9968E−13 | −4.0090E−15 |

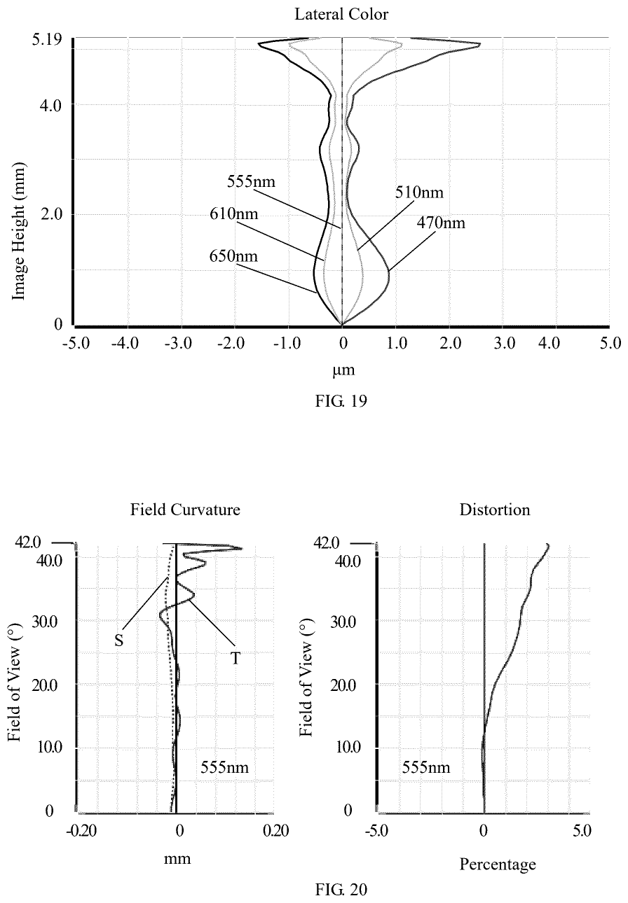

FIG. 18 and FIG. 19 respectively show schematic diagrams of longitudinal aberration and lateral color of light with wavelengths of 650 nm, 610 nm, 555 nm, 510 nm, and 470 nm after passing through the camera optical lens 50 of the fifth embodiment. FIG. 20 shows a schematic diagram of field curvature and distortion of light with a wavelength of 555 nm after passing through the camera optical lens 50 of the fifth embodiment. In FIG. 12, the field curvature S is a field curvature in a sagittal direction, and T is a field curvature in a meridian direction.

In this embodiment, the entrance pupil diameter ENPD of the camera optical lens 50 is 3.152 mm, the image height IH at the 1.0 field of view is 5.193 mm, the field of view FOV at the 1.0 field of view is 84.040, the image height IHm at the MIC field of view is 5.3 17 mm, and the field of view FOVm at the MIC field of view is 85.750. The camera optical lens 50 meets the design requirements of large aperture, wide-angle, and ultra-thinness, its on-axis and off-axis chromatic aberrations are sufficiently corrected, and it has excellent optical characteristics.

Table 13 appearing below shows the values of various numerical values in the first, second, third, fourth, and fifth embodiments that correspond to the parameters specified in the conditional expressions.

### Comparative Embodiment

The meaning of the symbols in the comparative embodiment is the same as that in the first embodiment.

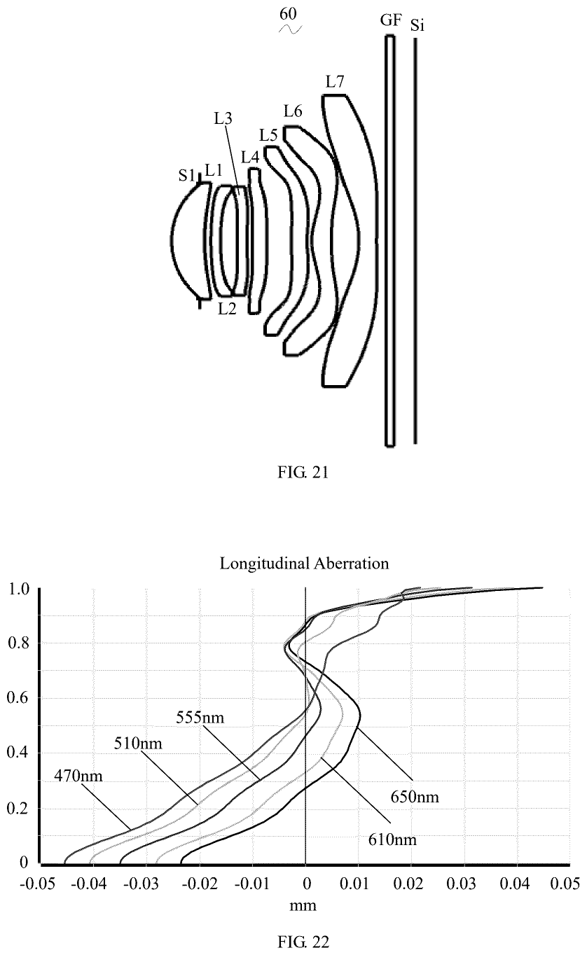

FIG. 21 shows a camera optical lens 60 of the comparative embodiment.

Table 11 shows design data of the camera optical lens 60 of the comparative embodiment.

TABLE 11

| | R | d | | nd | | vd | |
|---|---|---|---|---|---|---|---|
| S1 | ∞ | d0= | −0.72 | | | | |
| R1 | 1.922 | d1= | 0.840 | nd1 | 1.4959 | v1 | 81.65 |
| R2 | 5.268 | d2= | 0.158 | | | | |
| R3 | 6.794 | d3= | 0.248 | nd2 | 1.6700 | v2 | 19.39 |
| R4 | 5.439 | d4= | 0.424 | | | | |
| R5 | 19.431 | d5= | 0.249 | nd3 | 1.6700 | v3 | 19.39 |
| R6 | 10.411 | d6= | 0.131 | | | | |
| R7 | 11.757 | d7= | 0.368 | nd4 | 1.5444 | v4 | 55.82 |
| R8 | 34.572 | d8= | 0.633 | | | | |
| R9 | 9.123 | d9= | 0.393 | nd5 | 1.5661 | v5 | 37.71 |
| R10 | 2.183 | d10= | 0.122 | | | | |
| R11 | 1.398 | d11= | 0.505 | nd6 | 1.5444 | v6 | 55.82 |
| R12 | 12.312 | d12= | 0.701 | | | | |
| R13 | −2.554 | d13= | 0.450 | nd7 | 1.5346 | v7 | 55.69 |
| R14 | 13.467 | d14= | 0.239 | | | | |
| R15 | ∞ | d15= | 0.210 | ndg | 1.5168 | vg | 64.17 |
| R16 | ∞ | d16= | 0.538 | | | | |

Table 12 shows aspherical data of each of the lenses in the camera optical lens 60 of the comparative embodiment.

TABLE 12

| | Conic Coefficient | Aspherical Coefficient | | | | |
|---|---|---|---|---|---|---|
| | k | A4 | A6 | A8 | A10 | A12 |
| R1 | −1.7299E−01 | −3.1342E−03 | 5.7103E−02 | −3.0812E−01 | 1.1188E+00 | −2.7407E+00 |
| R2 | −2.3653E+01 | 9.3398E−03 | −2.1519E−02 | 1.0812E−01 | −4.4246E−01 | 1.1950E+00 |
| R3 | 1.9535E+01 | −2.4975E−02 | 1.3587E−02 | −5.6328E−02 | 2.8335E−01 | −8.8994E−01 |
| R4 | 6.3180E+00 | −1.8141E−03 | −7.5011E−02 | 8.7512E−01 | −5.3577E+00 | 2.1541E+01 |
| R5 | −1.4187E+02 | −4.1770E−02 | 2.3420E−02 | 1.0795E−01 | −1.5202E+00 | 7.6519E+00 |
| R6 | −6.0213E+00 | −6.4706E−02 | 9.7609E−02 | −2.1736E−01 | 1.8999E−01 | 5.0842E−01 |
| R7 | 4.1157E+01 | −7.1969E−02 | −1.8939E−02 | 4.7750E−01 | −2.2295E+00 | 6.0784E+00 |
| R8 | 2.5749E+01 | −5.5051E−02 | −1.0484E−02 | 2.6196E−01 | −1.0345E+00 | 2.2965E+00 |
| R9 | 1.3980E+01 | −1.6889E−01 | 3.1575E−01 | −5.1327E−01 | 6.5423E−01 | −6.4472E−01 |
| R10 | −1.3710E+00 | −5.8031E−01 | 8.9782E−01 | −1.2115E+00 | 1.3060E+00 | −1.0717E+00 |
| R11 | −2.8492E+00 | −2.7536E−01 | 4.3318E−01 | −5.7844E−01 | 5.7877E−01 | −4.3679E−01 |
| R12 | 9.4336E+00 | 9.0839E−02 | −8.0220E−02 | 4.9891E−02 | −3.3934E−02 | 1.7010E−02 |
| R13 | −2.2782E+00 | −3.0671E−02 | 4.6807E−02 | −3.2820E−02 | 1.6372E−02 | −5.5898E−03 |
| R14 | −4.8755E+01 | −5.0119E−02 | 4.6171E−02 | −3.1125E−02 | 1.3227E−02 | −3.6404E−03 |
| | Conic Coefficient | Aspherical Coefficient | | | | |
| | k | A14 | A16 | A18 | A20 | A22 |
| R1 | −1.7299E−01 | 4.6656E+00 | −5.6379E+00 | 4.8951E+00 | −3.0605E+00 | 1.3648E+00 |
| R2 | −2.3653E+01 | −2.1990E+00 | 2.8491E+00 | −2.6502E+00 | 1.7814E+00 | −8.5955E−01 |
| R3 | 1.9535E+01 | 1.9138E+00 | −2.8984E+00 | 3.1304E+00 | −2.4161E+00 | 1.3202E+00 |
| R4 | 6.3180E+00 | −5.9524E+01 | 1.1640E+02 | −1.6346E+02 | 1.6532E+02 | −1.1929E+02 |
| R5 | −1.4187E+02 | −2.3476E+01 | 4.8776E+01 | −7.1392E+01 | 7.4584E+01 | −5.5362E+01 |
| R6 | −6.0213E+00 | −2.3505E+00 | 4.7690E+00 | −6.1228E+00 | 5.3662E+00 | −3.2637E+00 |
| R7 | 4.1157E+01 | −1.1090E+01 | 1.4183E+01 | −1.2960E+01 | 8.4965E+00 | −3.9582E+00 |
| R8 | 2.5749E+01 | −3.3411E+00 | 3.3658E+00 | −2.4047E+00 | 1.2271E+00 | −4.4393E−01 |
| R9 | 1.3980E+01 | 4.7979E−01 | −2.6688E−01 | 1.1028E−01 | −3.3634E−02 | 7.4664E−03 |
| R10 | −1.3710E+00 | 6.5639E−01 | −2.9731E−01 | 9.8848E−02 | −2.3898E−02 | 4.1373E−03 |
| R11 | −2.8492E+00 | 2.4330E−01 | −9.8336E−02 | 2.8627E−02 | −5.9695E−03 | 8.8153E−04 |
| R12 | 9.4336E+00 | −4.7371E−03 | 3.3922E−04 | 2.2996E−04 | −9.3276E−05 | 1.7905E−05 |
| R13 | −2.2782E+00 | 1.2970E−03 | −2.0893E−04 | 2.3858E−05 | −1.9509E−06 | 1.1382E−07 |
| R14 | −4.8755E+01 | 6.6671E−04 | −8.2101E−05 | 6.7034E−06 | −3.4015E−07 | 8.2211E−09 |

| | Conic Coefficient | Aspherical Coefficient | | | |
|---|---|---|---|---|---|
| | k | A24 | A26 | A2 | A30 |
| R1 | −1.7299E−01 | −4.2320E−01 | 8.6652E−02 | −1.0527E−02 | 5.7438E−04 |
| R2 | −2.3653E+01 | 2.9075E−01 | −6.5552E−02 | 8.8574E−03 | −5.4308E−04 |
| R3 | 1.9535E+01 | −4.9778E−01 | 1.2291E−01 | −1.7829E−02 | 1.1469E−03 |
| R4 | 6.3180E+00 | 5.9873E+01 | −1.9852E+01 | 3.9078E+00 | −3.4579E−01 |
| R5 | −1.4187E+02 | 2.8533E+01 | −9.7091E+00 | 1.9614E+00 | −1.7815E−01 |
| R6 | −6.0213E+00 | 1.3592E+00 | −3.7056E−01 | 5.9685E−02 | −4.3109E−03 |
| R7 | 4.1157E+01 | 1.2771E+00 | −2.7099E−01 | 3.3987E−02 | −1.9082E−03 |
| R8 | 2.5749E+01 | 1.1110E−01 | −1.8275E−02 | 1.7759E−03 | −7.7194E−05 |
| R9 | 1.3980E+01 | −1.1718E−03 | 1.2293E−04 | −7.7104E−06 | 2.1799E−07 |
| R10 | −1.3710E+00 | −4.9875E−04 | 3.9728E−05 | −1.8791E−06 | 3.9967E−08 |
| R11 | −2.8492E+00 | −8.9924E−05 | 6.0255E−06 | −2.3866E−07 | 4.2354E−09 |
| R12 | 9.4336E+00 | −2.0598E−06 | 1.4467E−07 | −5.7392E−09 | 9.8850E−11 |
| R13 | −2.2782E+00 | −4.6357E−09 | 1.2544E−10 | −2.0287E−12 | 1.4844E−14 |
| R14 | −4.8755E+01 | 1.1424E−10 | −1.4409E−11 | 3.9968E−13 | −4.0090E−15 |

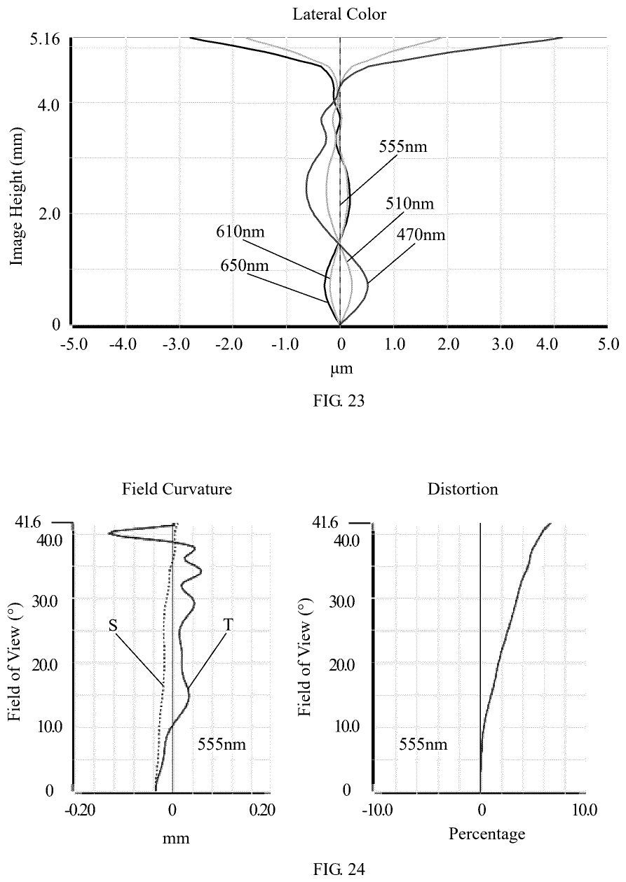

FIG. 22 and FIG. 23 respectively show schematic diagrams of longitudinal aberration and lateral color of light with wavelengths of 650 nm, 610 nm, 555 nm, 510 nm, and 470 nm after passing the camera optical lens 60 of the comparative embodiment. FIG. 24 shows a schematic diagram of field curvature and distortion of light with a wavelength of 555 nm after passing through the camera optical lens 60 of the comparative embodiment. In FIG. 12, the field curvature S is a field curvature in a sagittal direction, and T is a field curvature in a meridian direction.

In the comparative embodiment, the entrance pupil diameter ENPD of the camera optical lens 60 is 3.043 mm, the image height at the 1.0 field of view is 5.161 mm, the field of view FOV at the 1.0 field of view is 83.24, the image height IHm at the MIC field of view is 5.300 mm, and the field of view FOVm at the MIC field of view is 84.580.

Table 13 below lists, in accordance with the above-mentioned conditional expressions, the values corresponding to each of the conditional expressions in the first embodiment, the second embodiment, the third embodiment, the fourth embodiment, the fifth embodiment, and the comparative embodiment. Apparently, the data of the seventh lens L7 of the camera optical lens 60 of the comparative embodiment does not satisfy the conditional expression: 10.00≤(R13+R14)/d13≤23.00. Therefore, the camera optical lens 60 of the comparative embodiment does not meet the design requirements of large aperture, wide angle, and ultra-thinness.

TABLE 13

| Conditional | First | Second | Third | Fourth | Fifth | Comparative |
|---|---|---|---|---|---|---|
| Expressions | Embodiment | Embodiment | Embodiment | Embodiment | Embodiment | Embodiment |
| (R13 + R14)/d13 | 14.95 | 22.95 | 10.23 | 21.19 | 16.70 | 24.25 |
| R7/R8 | 0.37 | 0.25 | 0.70 | 0.32 | 0.35 | 0.34 |
| (f6 − f7)/f | 1.179 | 1.054 | 1.189 | 1.244 | 1.165 | 1.263 |
| (R5 − R6)/f3 | −0.28 | −1.35 | −0.10 | −0.17 | −1.05 | −0.27 |
| f12/(d1 + d2 + d3) | 4.89 | 4.40 | 4.71 | 5.39 | 3.90 | 4.95 |
| BF/TTL | 0.158 | 0.156 | 0.153 | 0.162 | 0.146 | 0.159 |
| f | 5.486 | 5.490 | 5.509 | 5.334 | 5.580 | 5.386 |
| f1 | 5.656 | 5.449 | 5.588 | 5.762 | 5.431 | 5.62 |
| f2 | −47.787 | −47.506 | −45.772 | −45.381 | −42.118 | −43.572 |
| f3 | −33.690 | −22.538 | −45.767 | −36.449 | −29.843 | −33.54 |
| f4 | 33.132 | 27.541 | 71.036 | 30.064 | 34.752 | 32.433 |
| f5 | −5.156 | −4.969 | −5.163 | −5.213 | −4.888 | −5.151 |
| f6 | 2.818 | 2.657 | 2.811 | 2.794 | 2.833 | 2.841 |
| f7 | −3.650 | −3.131 | −3.741 | −3.842 | −3.665 | −3.964 |
| FNO | 1.77 | 1.77 | 1.77 | 1.77 | 1.77 | 1.77 |
| TTL | 6.221 | 6.333 | 6.242 | 6.177 | 6.225 | 6.209 |
| IH | 5.161 | 5.117 | 5.182 | 5.156 | 5.193 | 5.161 |
| FOV | 85.00° | 83.42° | 85.50° | 86.60° | 84.04° | 83.24° |

It can be understood by those of ordinary skill in the art that the above embodiments are specific embodiments for implementing the present disclosure, and in practical applications, various changes may be made thereto in form and detail without departing from the spirit and scope of the present disclosure.

What is claimed is:

1. A camera optical lens, comprising seven lenses in order from an object side to an image side: a first lens having a positive refractive power, a second lens having a negative refractive power, a third lens having a negative refractive power, a fourth lens having a positive refractive power, a fifth lens having a negative refractive power, a sixth lens having a positive refractive power, and a seventh lens having a negative refractive power;
wherein a focal length of the camera optical lens is f, a focal length of the third lens is f3, a central radius of curvature of an object side surface of the third lens is R5, a central radius of curvature of an image side surface of the third lens is R6, a central radius of curvature of an object side surface of the fourth lens is R7, a central radius of curvature of an image side surface of the fourth lens is R8, a focal length of the sixth lens is f6, a focal length of the seventh lens is f7, a central radius of curvature of an object side surface of the seventh lens is R13, a central radius of curvature of an image side surface of the seventh lens is R14, and an on-axis thickness of the seventh lens is d13, and following relational expressions are satisfied:
$$- 1.35 \leq ( R 5 - R 6 ) / f3 \leq - 0.1 ;$$
$$0.25 \leq R 7 / R 8 \leq 0.7 ;$$
$$10. \leq ( R 13 + R 14 ) / d 13 \leq 23. ; and$$
$$1.05 \leq ( f6 - f7 ) / f \leq 1.35 .$$

2. The camera optical lens as described in claim 1, wherein a combined focal length of the first lens and the second lens is f12, an on-axis thickness of the first lens is d1, an on-axis distance from an image side surface of the first lens to an object side surface of the second lens is d2, an on-axis thickness of the second lens is d3, and a following relational expression is satisfied:
$$3. 90 \leq f 12 / ( d 1 + d 2 + d 3 ) \leq 5.4 .$$

3. The camera optical lens as described in claim 1, wherein a total track length of the camera optical lens is TTL, an on-axis distance from the image side surface of the seventh lens to an image plane is BF, and a following relational expression is satisfied:
$$0.145 \leq BF / TTL \leq 0.165 .$$

4. The camera optical lens as described in claim 1, wherein
$$10.22 \leq ( R 13 + R 14 ) / d 13 \leq 22.96 ; and$$
$$1.054 \leq ( f6 - f7 ) / f \leq 1.245 .$$

5. The camera optical lens as described in claim 1, wherein an object side surface of the first lens is convex in a paraxial region, and an image side surface of the first lens is concave in the paraxial region; and
a focal length of the first lens is f1, a central radius of curvature of the object side surface of the first lens is R1, a central radius of curvature of the image side surface of the first lens is R2, an on-axis thickness of the first lens is d1, a total track length of the camera optical lens is TTL, and following relational expressions are satisfied:
$$0.973 \leq f 1 / f \leq 1.081 ;$$
$$- 2.22 \leq ( R 1 + R 2 ) / ( R 1 - R 2 ) \leq - 2.01 ; and$$
$$0.126 \leq d 1 / TTL \leq 0.164 .$$

6. The camera optical lens as described in claim 1, wherein an object side surface of the second lens is convex in a paraxial region, and an image side surface of the second lens is concave in the paraxial region; and
a focal length of the second lens is f2, a central radius of curvature of the object side surface of the second lens is R3, a central radius of curvature of the image side surface of the second lens is R4, an on-axis thickness of the second lens is d3, a total track length of the camera optical lens is TTL, and following relational expressions are satisfied:
$$- 8.72 \leq f 2 / f \leq - 7.54 ;$$
$$8.61 \leq ( R 3 + R 4 ) / ( R 3 - R 4 ) \leq 9.87 ; and$$
$$0.036 \leq d 3 / TTL \leq 0.047 .$$

7. The camera optical lens as described in claim 1, wherein the object side surface of the third lens is convex in a paraxial region, and the image side surface of the third lens is concave in the paraxial region; and
an on-axis thickness of the third lens L3 is d5, a total track length of the camera optical lens is TTL, and following relational expressions are satisfied:
$$- 8.31 \leq f 3 / f \leq - 4.1$$
$$1.73 \leq ( R 5 + R 6 ) / ( R 5 - R 6 ) \leq 5.21 ; and$$
$$0.029 \leq d 5 / TTL \leq 0.043 .$$

8. The camera optical lens as described in claim 1, wherein the object side surface of the fourth lens is convex in a paraxial region, and the image side surface of the fourth lens is concave in the paraxial region; and
a focal length of the fourth lens is f4, and following relational expressions are satisfied:
$$5.01 \leq f 4 / f \leq 12.9 ; and$$
$$- 5.63 \leq ( R 7 + R 8 ) / ( R 7 - R 8 ) \leq - 1.67 .$$

9. The camera optical lens as described in claim 1, wherein an object side surface of the fifth lens is convex in a paraxial region, and an image side surface of the fifth lens is concave in the paraxial region; and
a focal length of the fifth lens is f5, a central radius of curvature of the object side surface of the fifth lens is R9, a central radius of curvature of the image side surface of the fifth lens is R10, and following relational expressions are satisfied:
$$- 0.98 \leq f 5 / f \leq - 0.87 ; and$$
$$1.516 \leq ( R 9 + R 10 ) / ( R 9 - R 10 ) \leq 1.641 .$$

10. The camera optical lens as described in claim 1, wherein an object side surface of the sixth lens is convex in a paraxial region, and an image side surface of the sixth lens is concave in the paraxial region; and
a central radius of curvature of the object side surface of the sixth lens is R11, a central radius of curvature of the image side surface of the sixth lens is R12, and following relational expressions are satisfied:
$$0.483 \leq f 6 / f \leq 0.524 ; and$$
$$- 1.25 \leq ( R 11 + R 12 ) / ( R 11 - R 12 ) \leq - 1.01 .$$

11. The camera optical lens as described in claim 1, wherein the object side surface of the seventh lens is concave in a paraxial region, and the image side surface of the seventh lens is concave in the paraxial region; and
a total track length of the camera optical lens is TTL, and following relational expressions are satisfied:
$$- 0.73 \leq f 7 / f \leq - 0.57 ;$$
$$- 0.75 \leq ( R 13 + R 14 ) / ( R 13 - R 14 ) \leq - 0.52 ; and$$
$$0.076 \leq d 13 / TTL \leq 0.095 .$$
